(19) United States
(12) Patent Application Publication
(10) Pub. No.: US 2011/0298921 A1
(43) Pub. Date: Dec. 8, 2011

(54) ROTATIONAL DRIVING DEVICE, IMAGE CAPTURING DEVICE, AND NETWORK CAMERA SYSTEM

(75) Inventors: Akinori OSADA, Fukuoka (JP); Yuuji TOYOMURA, Fukuoka (JP); Nobuhiro TUCHIHASHI, Fukuoka (JP)

(73) Assignee: PANASONIC CORPORATION, Osaka (JP)

(21) Appl. No.: 13/154,739

(22) Filed: Jun. 7, 2011

(30) Foreign Application Priority Data
Jun. 8, 2010 (JP) 2010-130689
Sep. 6, 2010 (JP) 2010-199323

(51) Int. Cl. H04N 7/18; H02K 41/035; H04N 5/225

(52) U.S. Cl. 348/143; 348/373; 310/12.14; 310/12.06; 348/E05.024; 348/E07.085

(57) ABSTRACT

A rotational driving device has a rotation body and a plurality of magnetic rotation drivers so as to rotate the rotation body by generating a magnetic force in a rotation direction. Provided in an area formed between the magnetic rotation drivers are a first magnetic sensor that detects a position of the rotation body in a radial direction; a second magnetic sensor that detects a position of the rotation body in an axial direction; a first electromagnet that controls the position of the rotation body in the radial direction by generating a radial-direction magnetic force; and a second electromagnet that controls the position of the rotation body in the axial direction by generating an axial-direction magnetic force. The rotational driving device is capable of providing a long-term dependability, inhibiting vibration, as well as using space effectively.

### CROSS-REFERENCE TO RELATED APPLICATIONS

The present application claims priority under 35 U.S.C. §119 of Japanese Applications No. 2010-130689, filed on Jun. 8, 2010, and No. 2010-199323, filed on Sep. 6, 2010, the disclosures of which are expressly incorporated by reference herein in their entireties.

### BACKGROUND OF THE INVENTION

1. Field of the Invention

The present invention relates to a rotational driving device that rotationally drives a rotation body displaceable in axial and radial directions and controls a position of the rotation body in the axial and radial directions, and an image capturing device and a network camera system having such a rotational driving device. In particular, the present invention relates to a rotational driving device that is suitable for obtaining a plurality of images by performing image capturing while slightly displacing optical images, formed on a light-receiving surface of an image capturing element, relative to the image capturing element, and an image capturing device and a network camera system having the rotational driving device.

2. Description of Related Art

An image capturing device employs an image capturing element in which pixels are arranged in a two-dimensional matrix pattern. The resolution of the image capturing element is limited because it depends on the size of pixels and the number of pixels in the image capturing element. To generate images having a higher resolution than that of the image capturing element itself, super-resolution processing is performed after so-called pixel offset (optical shift), in which a plurality of original images are captured, while optical images formed on a light-receiving surface of the image capturing element are slightly displaced relative to the image capturing element.

Such a technology of pixel offset requires an optical shift mechanism for slightly displacing the optical images and the image capturing elements with respect to each other (see Related Art 1).

For example, a parallel plate is provided between the image capturing element and a lens unit that forms images on the image capturing element based on light from an object. The parallel plate is inclined with respect to the optical axis of the lens unit, and the position of the optical image on a light-receiving surface of the image capturing element is displaced by rotating the parallel plate around the optical axis (see Related Art 2 and Related Art 3).

A monitoring camera system, for example, uses a pixel offset to obtain a high-resolution image, because the pixel offset is capable of generating a high-resolution image from a stored low-resolution image when the high-resolution image is necessary for the purpose of traffic accident investigation and the like.

In a case of using an image capturing device as a monitoring camera, long-term dependability (long life-span) such as consecutive ten-year stable operation is required. It is also desired that the image capturing device produces low noise so that the device may be used in a quiet environment. However, with the conventional technology disclosed in the Related Arts 2 and 3, the parallel plate is rotationally driven by transmitting a driving force of a motor to the parallel plate through a gear mechanism, therefore it is neither possible to secure sufficient dependability nor to reduce noise.

In order to realize a long-term dependability along with less vibration, consideration may be given to employing a bearingless motor technology that eliminates a mechanical bearing by combining a function of a magnetic bearing with a brushless motor. With the bearingless motor, however, because a rotor may be displaced from a regular position, it is required to further have a detector that detects a position of a rotor and a controller that controls a position of the rotor based on the detection result, thereby making it difficult to reduce the component size.

Related Art 1: Japanese Patent Application Publication No. 2008-306492

Related Art 2: Japanese Patent Application Publication No. 2000-125170

Related Art 3: Japanese Patent Application Publication No. 2000-278614

### SUMMARY OF THE INVENTION

In view of the above circumstances, an object of the present invention is to provide a rotational driving device and an image capturing device, and a network camera system having such devices, which are capable of providing a long-term dependability, inhibiting vibration, as well as using space effectively.

The rotational driving device according to the present invention includes a rotation body; a first magnetizer that is provided to the rotation body and faces an outer side of the rotation body in a radial direction; a second magnetizer that is provided to the rotation body and faces one end of the rotation body in an axial direction; and a plurality of magnetic rotation drivers that rotate the rotation body by generating a magnetic force in a rotation direction between the first magnetizer and the magnetic rotation driver. A first position detector detects a position of the rotation body in the radial direction based on magnetism of the first magnetizer; a second position detector detects a position of the rotation body in the axial direction based on magnetism of the second magnetizer; a first position controller controls the position of the rotation body in the radial direction by generating a radial-direction magnetic force between the first magnetizer and the first position controller based on a detection result by the first position detector; and a second position controller controls the position of the rotation body in the axial direction by generating an axial-direction magnetic force between the second magnetizer and the second position controller based on a detection result by the second position detector. The first position detector, the second position detector, the first position controller, and the second position controller are provided in an area formed between the magnetic rotation drivers

In the present invention, the first and second position controllers control the position of the rotation body in axial and radial directions so that a need for a mechanical bearing is eliminated, thereby making it possible to provide a rotational driving device having a longer life and less vibration. Further, the first and second position detectors and the first and second position controllers are provided in the area between the magnetic rotation drivers. Therefore, spaces around the rotation body can be used efficiently so as to provide a space-saving effect.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates an overall configuration of a network camera system according to the present invention;

FIG. 2 is a block diagram illustrating a schematic configuration of an image capturing device and an image processing device shown in FIG. 1;

FIG. 3 is a schematic diagram illustrating processing statuses in the image capturing device and the image processing device shown in FIG. 1;

FIG. 4 is a longitudinal section view showing an image capturing device having a rotational driving device according to a first embodiment of the present invention;

FIG. 5 is a longitudinal section view showing an image capturing device having a rotational driving device according to a second embodiment of the present invention;

FIGS. 6A and 6B illustrate orientations of easy axes of magnetization in anisotropy magnets;

FIGS. 7A and 7B are sectional views showing a main portion of a rotation body and a magnetic force when magnetized in an anisotropy orientation.

FIG. 8 is a plan view showing an optical shift mechanism shown in FIG. 4;

FIG. 9A is a plan view showing a rotational driving device shown in FIG. 8;

FIG. 9B is one example of applying a conventional configuration of a rotational driving device having a three-phase motor, which is used as a base of the rotational driving device of FIG. 9A;

FIGS. 10A and 10B are plan views showing a rotational driving device according to a second variation of the present invention;

FIGS. 11A and 11B are plan views showing a rotational driving device according to a third variation of the present invention;

FIG. 12 illustrates a configuration of a shift controller shown in FIG. 2;

FIG. 13 illustrates a main portion of the rotational driving device shown in FIG. 4, and the shift controller;

FIG. 14 illustrates a main portion of the rotational driving device shown in FIG. 5, and the shift controller;

FIG. 15 is a cross-sectional view showing a main portion of the rotational driving device according to the first variation of the present invention;

FIGS. 16A and 16B are cross-sectional views showing incidence status of light transmitted toward the image capturing element shown in FIG. 4;

FIGS. 17A and 17B are schematic diagrams illustrating statuses of circular motions of pixels relative to an optical image;

FIGS. 18A, 18B, and 18C are schematic diagrams illustrating statuses of circular motions of pixels relative to an optical image;

FIG. 19 is a schematic diagram illustrating a status of an image capturing and an image generated from the image capturing; and

FIGS. 20A, 20B, and 20C are schematic diagrams illustrating statuses of image capturing reference positions in one example of a ratio of an image capturing period to a circular motion period.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for a fundamental understanding of the present invention, the description taken with the drawings making apparent to those skilled in the art how the fauns of the present invention may be embodied in practice.

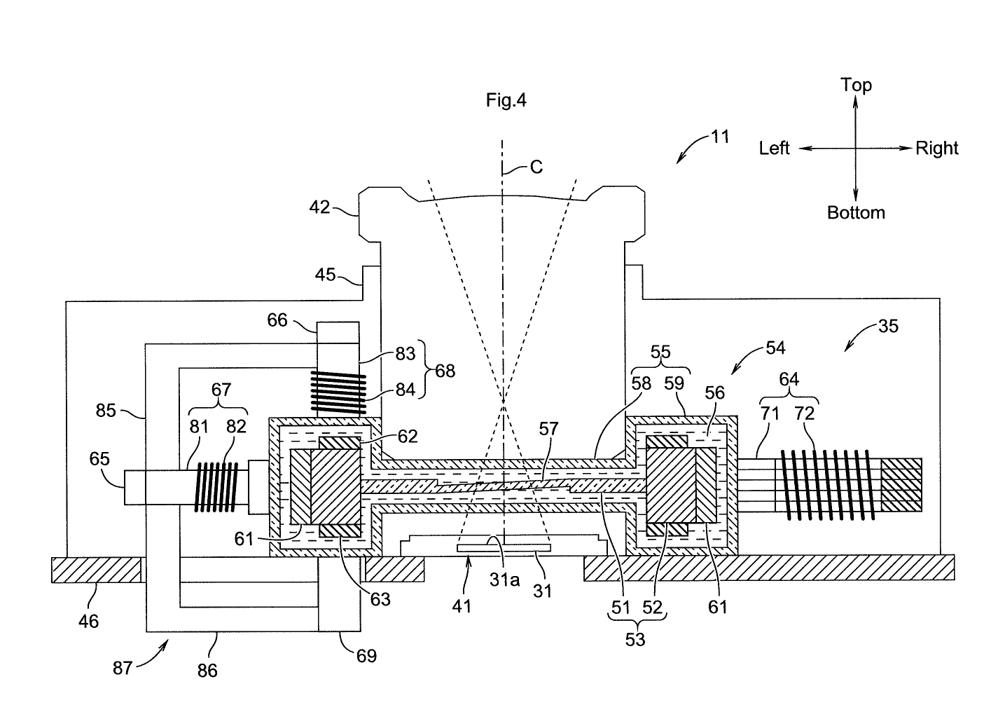

Embodiments of the present invention will now be described with reference to the accompanying drawings. In the following description, the “axial” direction refers to the direction of the optical axis (corresponding to the top-bottom direction in FIG. 4), and the “radial” direction refers to the direction perpendicular to the optical axis (corresponding to the left-right direction in FIG. 4). The radial direction can be any angle within 360 degrees around the optical axis.

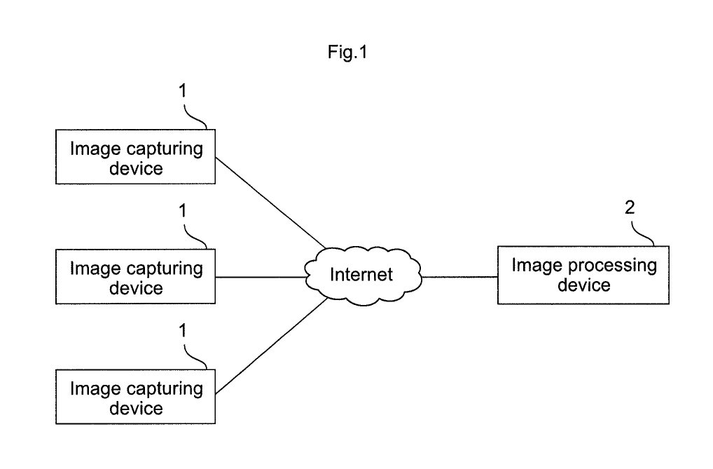

FIG. 1 illustrates an overall configuration of a network camera system according to the present invention. As shown in FIG. 1, the network camera system to which the present invention is applied includes at least one image capturing device (a network camera, for example) 1, and an image processing device (a host device, for example) 2. The image capturing device 1 and the image processing device 2 are connected through the Internet, and captured image data generated by the image capturing device 1 is transmitted to the image processing device 2 located, for example, in a distant place so as to display the screen image on the image processing device 2. Various kinds of command signals that control the image capturing device 1 are transmitted from the image processing device 2 to the image capturing device 1.

Incidentally, the captured image data is transmitted from the image capturing device to the image processing device by use of an Internet Protocol such as TCP (UDP)/IP. However, it may be transmitted by use of VPN (Virtual Private Network), for example, after encryption or encapsulation. It is also possible to use a network camera system called as CCTV (Closed Circuit TV) in which the image capturing device 1 and the image processing device 2 are connected one-on-one by a private line. Of course, other protocols can be used.

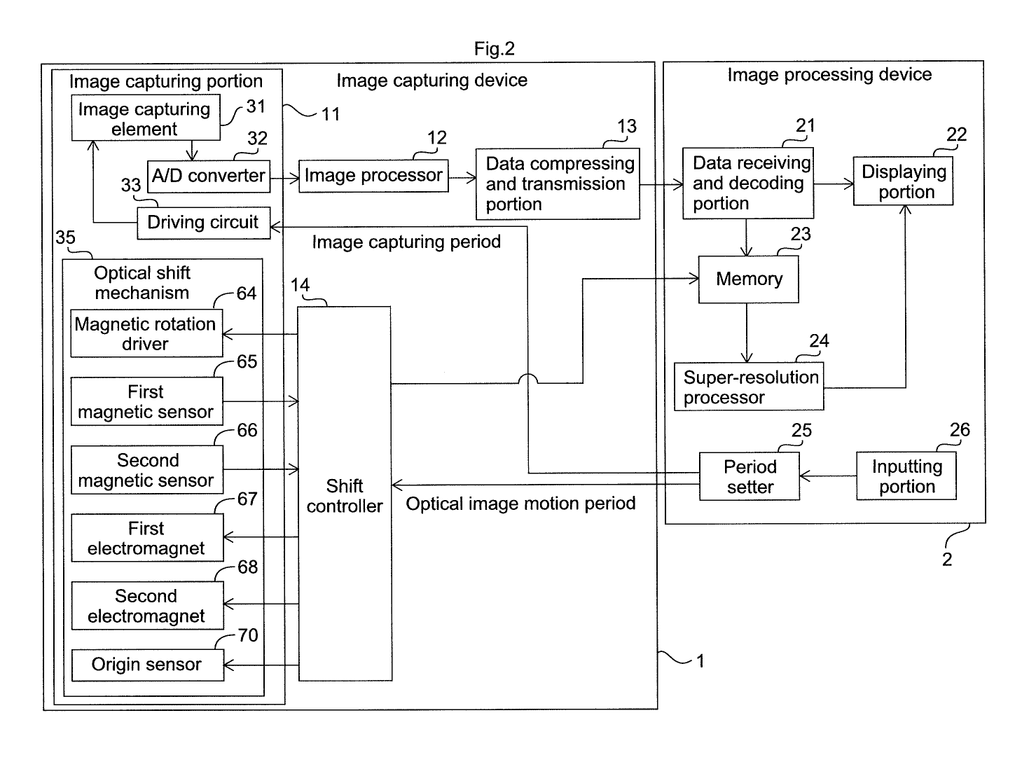

FIG. 2 is a block diagram illustrating a schematic configuration of the image capturing device and the image processing device shown in FIG. 1. As shown in FIG. 2, the image capturing device 1 has an image capturing portion 11, an image processor 12, a data compressing and transmitting portion 13, and a shift controller 14. The image capturing portion 11 has an image capturing element 31 that performs photoelectric conversion of light from an object and outputs an analog pixel signal. The image capturing element 31 can be a two-dimensional CMOS image sensor. Alternatively, a two-dimensional CCD image sensor or another sensor may be used for the image capturing element 31.

The analog signal output from the image capturing element 31 is converted into a digital signal in an A/D convertor 32. The digital signal is input into the image processor 12 where processing such as color correction, demosaic processing, tone correction (γ correction), YC separation processing and the like is performed, and the signal is converted into an image data. Compression processing such as by H.264 or MPEG4 is performed on the image data, and thereafter the data is transmitted to the image processing device 2.

The image capturing portion 11 has an optical shift mechanism 35 that slightly displaces optical images formed on a light-receiving surface of the image capturing element 31 relative to the image capturing element 31. The shift controller 14 controls operations performed by each component of the optical shift mechanism 35.

A configuration of the optical shift mechanism 35 and control by the shift controller 14 are described in detail later, and only an outline thereof is explained here. A rotation body (see numerical reference 53 in FIG. 4) having an optical member (see numerical reference 51 in FIG. 4) that slightly displaces optical images is rotationally driven by a magnetic rotation driver 64, and a position of the rotation body in radial and axial directions is detected by a first magnetic sensor 65 and a second magnetic sensor 66. A position of the rotation body in the radial and axial directions is controlled by a first electromagnet 67 and a second electromagnet 68. A rotation position of the rotation body is detected by an origin sensor 70.

The rotation body is provided with magnetizers (see numerical references 61 and 62 in FIG. 4). The first magnetic sensor 65 and the second magnetic sensor 66 detect the magnetism of the magnetizers and output the data to the shift controller 14. The shift controller 14 controls the magnetic rotation driver 64 based on the position information of the rotation body indicated by the output from the first magnetic sensor 65 and the second magnetic sensor 66 so as to rotate the optical member. The shift controller 14 also controls the first electromagnet 67 and the second electromagnet 68 so as to keep the optical member at a predetermined position.

The image processing device 2 is provided with a data receiving and decoding portion 21, a displaying portion 22, a memory 23, a super-resolution processor 24, a period setter 25, and an inputting portion 26. The image processing device 2 may be formed by installing required application software in an information processing device such as a personal computer, a work station, or the like. Alternatively, the image processing device 2 may be an exclusive device such as a CCTV recorder.

In the image processing device 2, the compressed image data transmitted from the image capturing device 1 is received and decoded by the data receiving and decoding portion 21, and thereafter converted into image data of RGB so as to be displayed in real time on the displaying portion 22 including a display and the like. Further, the image data of RGB is sent to the memory 23 which can include a hard disc drive device and the like, and is temporarily stored to be read out from the memory 23 and played on the displaying portion 22 as needed.

In case that a high-resolution image is needed, for example, to investigate a traffic accident or the like, the image data is read out from the memory 23; super-resolution processing is performed on the data in the super-resolution processor 24 so as to generate a high-resolution image (stationary image); and the high-resolution image is displayed on the displaying portion 22.

The inputting portion 26, as described in detail later, receives the input of the image capturing period from a user, and sends the image capturing period to the period setter 25. The period setter 25 determines a circular motion period based on the image capturing period sent from the inputting portion 26, and transmits a command signal regarding the circular motion period to the image capturing device 1. The shift controller 14 of the image capturing device 1 operates the optical shift mechanism 35 based on the command signal regarding the circular motion period so as to rotationally drives the optical member at a rotation speed corresponding to the designated circular motion period.

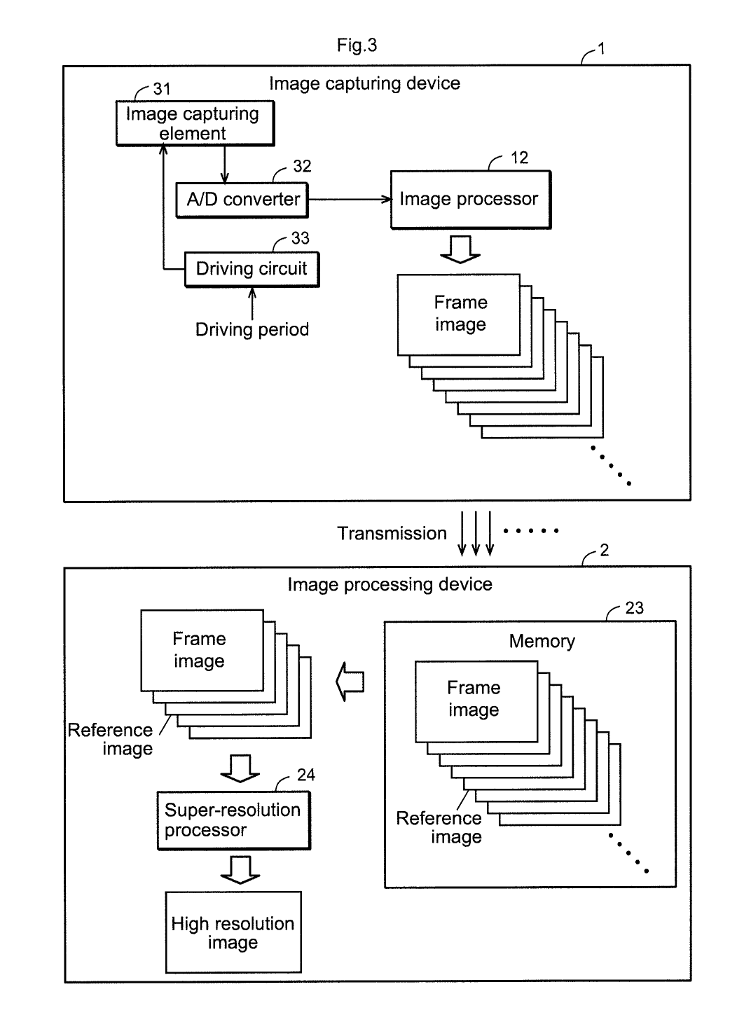

FIG. 3 is a schematic diagram illustrating processing status in the image capturing device 1 and the image processing device 2. As shown in FIG. 3, the image capturing element 31 is driven by a driving circuit 33, and image capturing (sampling) is performed at a predetermined period (hereinafter, image capturing period) corresponding to a timing signal generated by the driving circuit 33. For example, when 30 sets of frame images are generated per second, i.e., at a rate of 30 frames/sec, the image capturing period is set at around 30 ms.

In the super-resolution processor 24 of the image processing device 2, super-resolution processing is performed to generate high-resolution images from a plurality of frame images which are temporally consecutive. In the super-resolution processing, first, the frame images stored in the memory 23 are displayed as stationary images by frame-by-frame playback. Next, when a user designates a reference image from the images, the frame image as the reference image and a plurality of previous and following frame images of the reference image are read out from the memory 23 and sent to the super-resolution processor 24 so as to undergo super-resolution processing.

As the super-resolution processing, an ML (Maximum-likelihood) method, a MAP (Maximum A Posterior) method, or a POCS (Projection On to Convex Sets) method is used, and the super-resolution processing is performed by operating application software in a CPU. In general, super-resolution processing requires a large amount of computing, and thus, a part of the processing may be performed by using a GPU (Graphic Processing Unit) or exclusive hardware.

Here, the ML method refers to a method that uses a square of an error between the pixel value of the low-resolution image estimated based on the high-resolution image and the actually observed pixel value as an evaluation function, and adopts a high-resolution image that minimizes the evaluation function as an estimated image. In sum, the ML method is a super-resolution processing method based on the principle of the most-probable estimation. The MAP method refers to a method that estimates a high-resolution image that minimizes an evaluation function in which probability information of the high-resolution image is added to a square of the error. In sum, the MAP method is a super-resolution processing method that estimates a high-resolution image as an optimization issue to maximize the posterior probabilities by using prospective information with respect to the high-resolution image. The POCS method is a super-resolution processing method that obtains a high-resolution image by forming simultaneous equations regarding the pixel values of the high-resolution image and the low-resolution image, and solving the equations sequentially.

These super-resolution methods include a process in which a high-resolution image is assumed, the pixel value of a low-resolution image is estimated from the assumed high-resolution image based on a point spread function (PSF function) obtained from a camera model, and a high-resolution image that reduces the difference between the estimated value and the observed pixel value (observed value) is searched. Therefore, these super-resolution methods are called reconstruction-based super-resolution processing.

Here, the process for searching the high-resolution image is to confirm where the pixel obtained as the low-resolution image is located in the high-resolution image, and it is called a “positioning” process. In general, in super-resolution processing, the positioning process is carried out repeatedly and broadly with respect to the vicinity of the focused pixel so as to achieve high resolution even in a case where variation in the pixel position among a plurality of low-resolution images is unclear. Consequently, it is known that the calculation cost becomes extremely high. In contrast, as described in detail later, according to the present invention, the position of the pixel shifted by the optical shift mechanism 35 is known, and each frame image, i.e., a low-resolution image is captured in the known position. With respect to at least a stationary object, therefore, it becomes possible to omit most of the positioning processes by the optical shift, which results in great reduction in the calculation cost.

Incidentally, a super-resolution processing using image information over a plurality of temporally consecutive frames is specifically called multi-frame reconstruction-based super-resolution processing. On the other hand, it is called one frame reconstruction-based super-resolution in a case where reconstruction-based super-resolution processing is performed in a single frame. The present embodiment employs multi-frame reconstruction-based super-resolution processing.

Incidentally, here, a stationary image that became a high-resolution image by the super-resolution processing is played by the image processing device 2. When the processing capacity of the image processing device 2 is sufficiently high, however, it is also possible to play a moving image using the high-resolution image obtained by the super-resolution processing as a frame image.

### FIRST EMBODIMENT

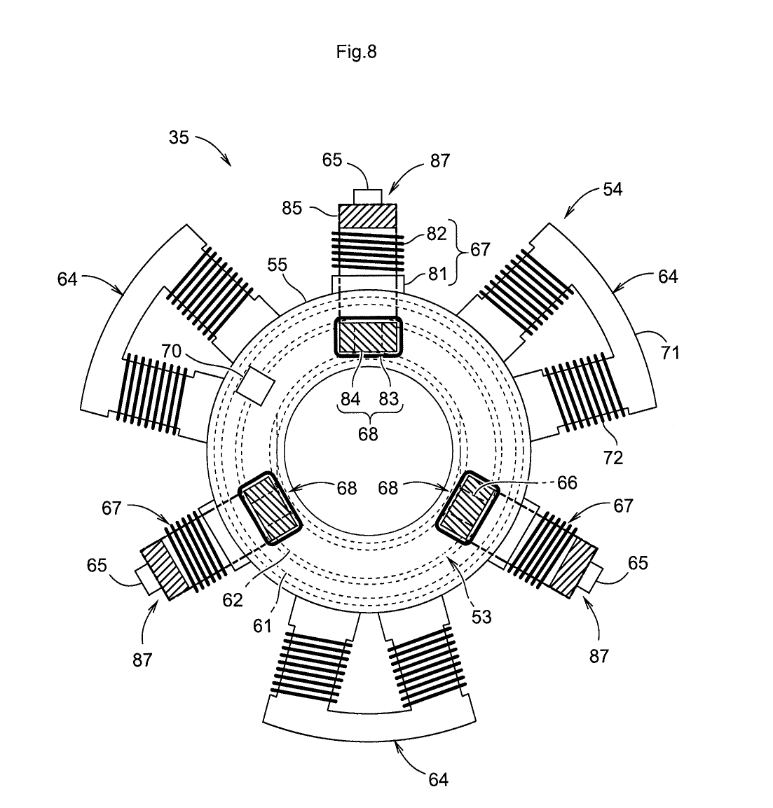

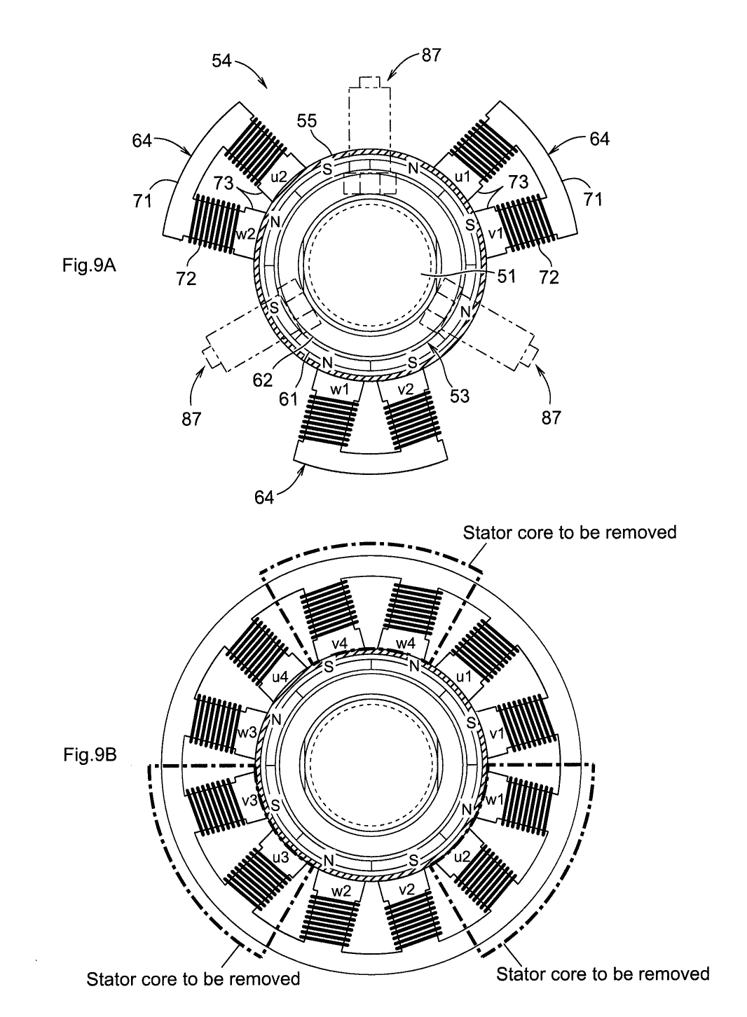

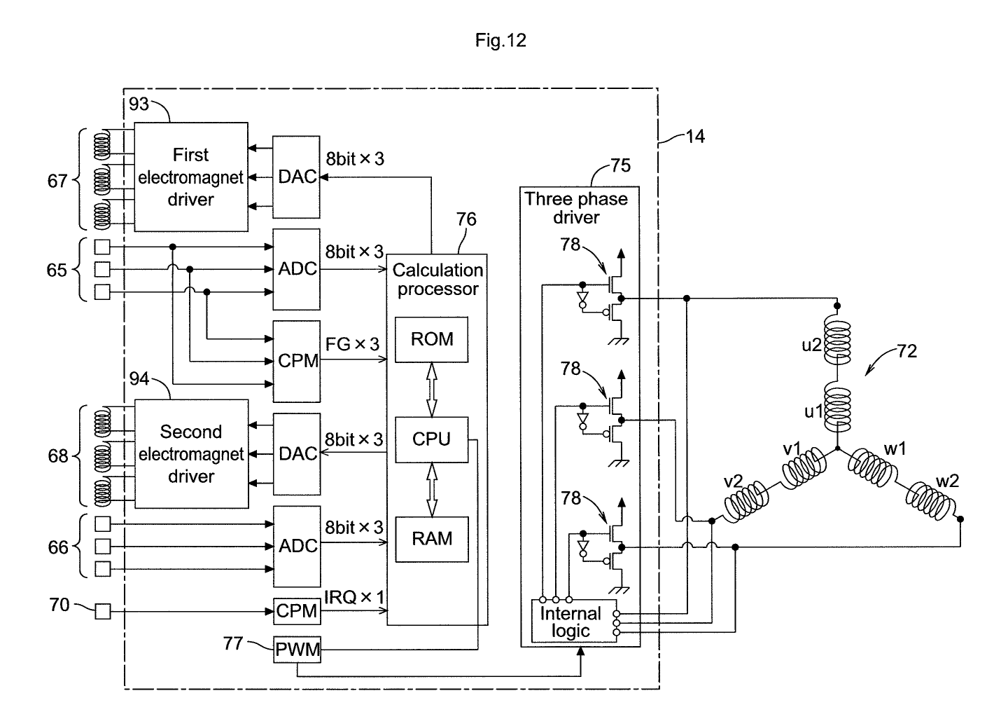

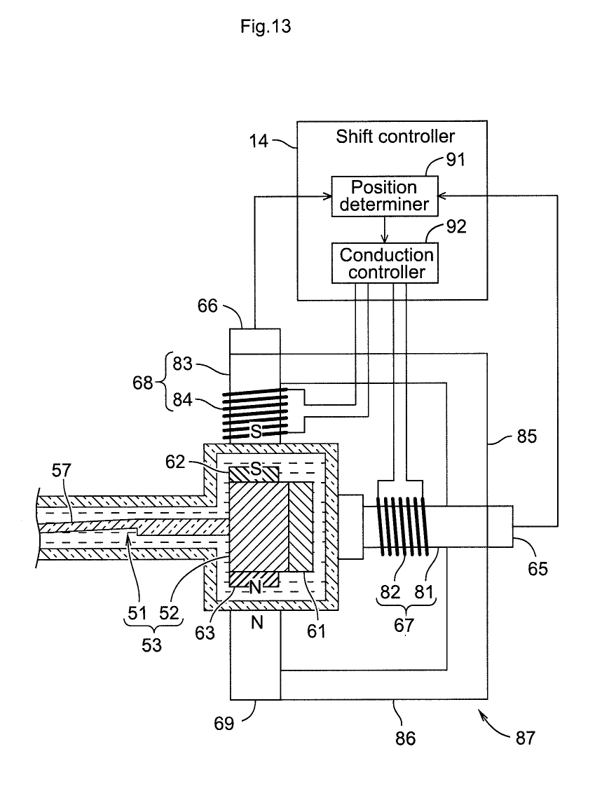

FIG. 4 is a longitudinal section view showing the image capturing portion 11 of the image capturing device 1 having the rotational driving device according to a first embodiment of the present invention. FIG. 8 is a plan view showing the optical shift mechanism 35 shown in FIG. 4. FIG. 9A is a plan view showing a rotational driving device 54 shown in FIG. 8, and FIG. 9B is a plan view showing one example of applying a conventional configuration of a rotational driving device having a three-phase motor, which is used as a base of the rotational driving device 54. FIG. 12 illustrates a configuration of a shift controller 14 shown in FIG. 2. FIG. 13 illustrates a main portion of the rotational driving device 54 shown in FIG. 4 and the shift controller 14.

As shown in FIG. 4, the image capturing portion 11 of the image capturing device 1 is provided with a sensor module 41, a lens unit 42, and an optical shift mechanism 35. The sensor module 41 has an image capturing element 31. The lens unit 42 forms an image based on light from an object (not shown in the drawing) onto a light-receiving surface 31a of the image capturing element 31. The optical shift mechanism 35 displaces an optical image formed on the light-receiving surface 31a of the image capturing element 31. The lens unit 42 is supported by a base 46 through a lens holder 45. The sensor module 41 and the optical shift mechanism 35 are also supported by the base 46. Other electrical components may be installed on the base 46 as needed.

The optical shift mechanism 35 is provided with a rotation body 53 and a rotational driving device 54. The rotation body 53 is configured with an optical member 51 and a supporting ring 52 that supports the optical member 51. The rotational driving device 54 rotationally drives the rotation body 53. The optical member 51 is stored in an optical capsule (capsule member) 55, filled with a liquid 56. The rotation body 53 is provided in the liquid 56 in a floating state while being displaceable in axial and radial directions. The rotational driving device 54 rotationally drives the rotation body 53.

The optical member 51 has a substantially circular plate shape, and is provided at the center thereof with a parallel plate 57 that is inclined at a predetermined angle with respect to an optical axis C of the lens unit 42. With the parallel plate 57 rotating, it is possible to slightly displace an optical image formed on the light-receiving surface 31a of the image capturing element 31 relative to the image capturing element 31. A material that forms the optical member 51 is not limited to optical glass, and other materials such as an acrylic resin or the like may be used.

A liquid having a higher refractive index than that of the air and a lower refractive index than that of a parallel plate 57 is employed as the liquid 56 that fills the optical capsule 55. Accordingly, a shift width of the parallel board 57 becomes substantially narrower than that of the parallel board 57 provided in the air, thereby making it possible to suppress a change amount of the optical shift that occurs when a center axis of the parallel board 57 is inclined due to vibration and the like of the optical member 51 in the optical capsule 55.

For the liquid 56 filled in the optical capsule 55, anti-freeze solution (a mixture of polypropylene glycol and water, for example) may be used. With this, it is possible to expand a temperature range (up to −20° C., for example) in which an image capturing device can be used. Further, with increased viscosity of the liquid 56, cushioning effect against outside impacts is improved, thereby making it possible to prevent the optical member 51 from being damaged. Furthermore, the refractive index of the liquid 56 can easily be adjusted by changing the viscosity of the anti-freeze solution, therefore a desired optical shift amount can easily be obtained.

The optical capsule 55 has a cross section that is narrow in the center. The optical capsule 55 has a central portion 58 that defines a circular plate space around the optical axis C; and an annular portion 59 that extends to the outer periphery of the central portion 58 and defines an annular space having a rectangular cross section. While the parallel plate 57 is housed in the central portion 58, an outer peripheral portion of the optical member 51 and the supporting ring 52 and the like are housed in the annular portion 59, which is vertically extended.

The optical capsule 55 is made of a transparent material with relatively high magnetic permeability such as a resin, a glass material or the like. Resins such as polycarbonate, acryl, cyclic olefin copolymer (COC), cyclic olefin polymer (COP) or the like may be used.

The entire body of the optical capsule 55 does not need to be made of a transparent material, as long as a portion corresponding to a light path where light from the lens unit 42 passes through is made of the transparent material described above. The area other than the light path of the optical capsule 55 may be non-transparent (for example, black), thereby making it possible to prevent unwanted light, in other words, stray light, from entering the image capturing element 31.

The supporting ring 52 has a substantially circular ring shape and holds the optical member 51 on an inner peripheral side thereof The supporting ring 52 is made of a magnetic material (for example, iron-based material) and acts as a back yoke. When the liquid 56 includes water, there is a likelihood that rust will occur in the supporting ring 52. In order to prevent the rust, a resin coating, a non-magnetic material plating or the like may be applied to the surface of the supporting ring 52. Although a magnetic property slightly deteriorates, it is also possible to prevent the rust from occurring by making the supporting ring of a non-magnetic metal material such as SUS316 and the like, a resin, or the like.

The liquid 56 in the optical capsule 55 is not limited to anti-freeze solution. It is possible to fill the optical capsule 55 with another fluid, such as water, for example, having a higher refractive index than that of the air and a lower refractive index than that of the parallel plate 57. Also, the anti-freeze solution does not need to be water-based. For example, transparent silicone oil may be employed. Because there is no likelihood that rust will occur in the supporting ring 52 and the like in this case, an anti-rust treatment such as a resin coating or the like is not necessary.

The rotational driving device 54 is provided with a first magnetizer 61, a second magnetizer 62, a third magnetizer 63, a magnetic rotation driver 64, a first magnetic sensor (first position detector) 65, a second magnetic sensor (second position detector) 66, a first electromagnet (first position controller) 67, a second electromagnet (second position controller) 68, and a permanent magnet 69. The first magnetizer 61 is provided to the rotation body 53 so as to face an outer side thereof in the radial direction. The second magnetizer 62 is provided to the rotation body 53 so as to face a first end thereof in the axial direction. The third magnetizer 63 is provided to the rotation body 53 so as to face a second end thereof in the axial direction. The magnetic rotation driver 64 rotates the rotation body 53 by generating a magnetic force in a rotation direction between the first magnetizer 61 and the magnetic rotation driver 64. The first magnetic sensor 65 detects a position of the rotation body 53 in the radial direction based on magnetism of the first magnetizer 61. The second magnetic sensor 66 detects a position of the rotation body 53 in the axial direction based on magnetism of the second magnetizer 62. The first electromagnet 67 controls a position of the rotation body 53 in the radial direction by generating a magnetic force in the radial direction between the first magnetizer 61 and the first electromagnet 67 based on a detection result by the first magnetic sensor 65. The second electromagnet 68 controls a position of the rotation body 53 in the axial direction by generating a magnetic force in the axial direction between the second magnetizer 62 and the second electromagnet 68 based on a detection result by the second magnetic sensor 66. The permanent magnet 69 maintains the rotation body 53 at a predetermined position in the axial direction by generating a magnetic force in the axial direction reversely oriented with respect to the magnetic force generated by the second electromagnet 68 between the third magnetizer 63 and the permanent magnet 69.

The first magnetizer 61 has a cylinder shape, is coaxial with the rotation body 53, and is fixed to an outer peripheral of the supporting ring 52. The second magnetizer 62 has a cylinder shape, is coaxial with the rotation body 53, and is fixed to an upper end surface of the supporting ring 52. The third magnetizer 63 has a cylinder shape similar to the second magnetizer 62, and is fixed to a lower end surface of the supporting ring 52 opposite to the second magnetizer 62. Along with the rotation body 53, the first magnetizer 61, the second magnetizer 62, and the third magnetizer 63 are housed in the optical capsule 55.

It is preferable to employ a plastic magnet for the first magnetizer 61, the second magnetizer 62, and the third magnetizer 63. In particular, when using a plastic magnet made of polyphenylene sulfide (PPS) resin in which minute magnetic particles are dispersed and mixed, water absorption and swelling can be prevented even in the liquid 56 that contains water. It is also preferable to use neodymium as the magnetic particles. Because the neodymium can provide an extremely large magnetic force, large driving torque can be achieved especially in the first magnetizer 61, and therefore it is effective when the viscosity of the liquid 56 is large at low temperature. However, since the neodymium used in a magnetic body becomes oxidized by water and generates rusts, it is preferable to prevent the neodymium from directly contacting the liquid 56 by coating the surface of the neodymium with a resin material or a non-magnetic material. The magnetic particles are not limited to neodymium, and it is possible to use, for example, ferrite, samarium cobalt, or the like. When the ferrite is used as the magnetic particles, a resin coating or the like mentioned above is not necessary since there is no likelihood of rusting.

As stated earlier, the rotation body 53 is only provided with permanent magnets such as the first magnetizer 61, the second magnetizer 62, and the third magnetizer 63. Because no conductive wire needs to be introduced into the optical capsule 55, the sealing properties of the optical capsule 55 can be improved. Also, increased independency of the optical capsule 55 as a member is beneficial in a production process.

### SECOND EMBODIMENT

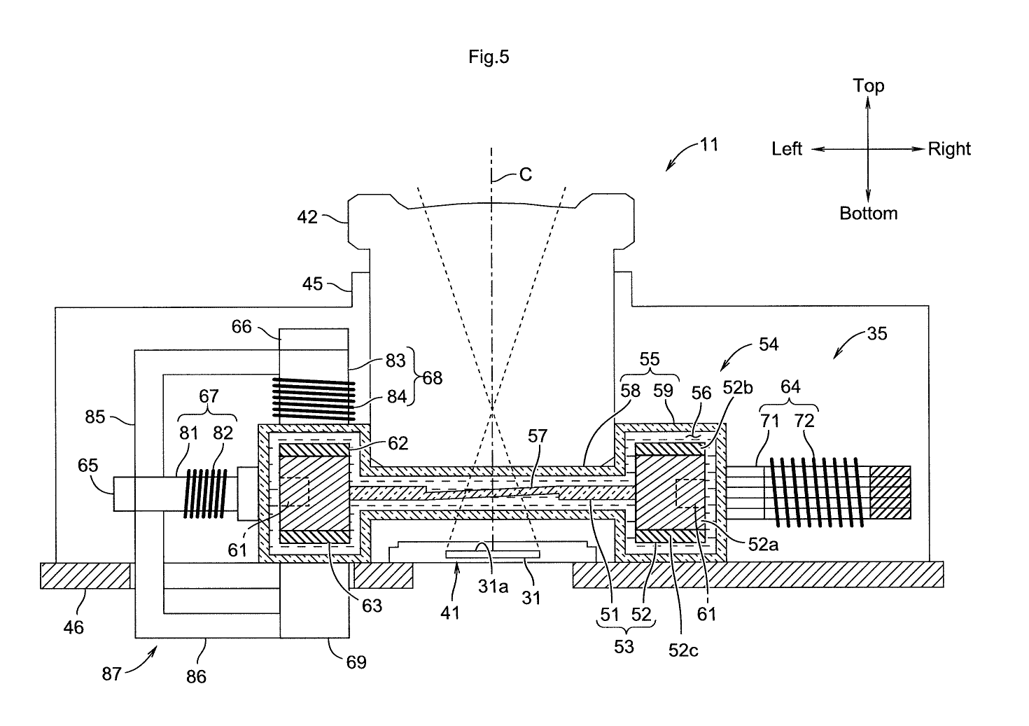

FIG. 5 is a longitudinal section view showing the image capturing portion 11 of the image capturing device 1 according to a second embodiment of the present invention.

As shown in FIG. 5, the image capturing portion 11 of the image capturing device 1 is provided with the sensor module 41, the lens unit 42, and the optical shift mechanism 35. The sensor module 41 has the image capturing element 31. The lens unit 42 forms an image based on light from an object (not shown in the drawing) onto the light-receiving surface 31 a of the image capturing element 31. The optical shift mechanism 35 displaces an optical image formed on the light-receiving surface 31a of the image capturing element 31. The lens unit 42 is supported by the base 46 through the lens holder 45. The sensor module 41 and the optical shift mechanism 35 are also supported by the base 46. Other electrical components may be installed on the base 46 as needed.

The optical shift mechanism 35 is provided with the rotation body 53 and the rotational driving device 54. The rotation body 53 is configured with the optical member 51 and the supporting ring 52 that is disposed on the outer peripheral surface of the optical member 51. The rotational driving device 54 rotationally drives the rotation body 53. The rotation body 53 is housed in the optical capsule (capsule member) 55, which is filled with the liquid 56. The rotation body 53 is provided in the liquid 56 in a floating state while being displaceable in axial and radial directions, and is driven by the rotational driving device 54.

The optical member 51 has a substantially circular plate shape, and is provided at the center thereof with a parallel plate 57 that is inclined at a predetermined angle with respect to an optical axis C of the lens unit 42. With the parallel plate 57 rotating, it is possible to slightly displace an optical image formed on the light-receiving surface 31a of the image capturing element 31 relative to the image capturing element 31. A material that forms the optical member 51 is not limited to optical glass, and other materials such as an acrylic resin or the like may be used.

A liquid having a higher refractive index than that of the air and a lower refractive index than that of a parallel plate 57 is employed for the liquid 56 that fills the inside of the optical capsule 55. Accordingly, a shift width of the parallel board 57 becomes substantially narrower than that of the parallel board 57 provided in the air, thereby making it possible to suppress a change amount of the optical shift that occurs when a center axis of the parallel board 57 is inclined due to vibration and the like of the optical member 51 in the optical capsule 55.

For the liquid 56 in the optical capsule 55, an anti-freeze solution (a mixture of polypropylene glycol and water, for example) may be used. With this, it is possible to expand a temperature range (up to −20° C., for example) in which the image capturing device 1 can be used. Further, with increased viscosity of the liquid 56, a cushioning effect against outside impacts is improved, thereby making it possible to prevent the optical member 51 from being damaged. Furthermore, the refractive index of the liquid 56 can easily be adjusted by changing the viscosity of the anti-freeze solution, therefore a desired optical shift amount can easily be obtained.

The optical capsule 55 has a cross section that is narrow in the center. The optical capsule 55 is provided with a central portion 58 that defines a circular plate space around the optical axis C; and an annular portion 59 that extends to the outer periphery of the central portion 58 and defines an annular space having a rectangular cross section. While the parallel plate 57 is housed in the central portion 58, an outer peripheral portion of the optical member 51 and the supporting ring 52 and the like are housed in the annular portion 59, which is vertically extended.

The optical capsule 55 is made of a transparent material with relatively high magnetic permeability such as a resin, a glass material or the like. As non-limiting examples, resins such as polycarbonate, acryl, cyclic olefin copolymer (COC), cyclic olefin polymer (COP) or the like may be used. The entire body of the optical capsule 55 does not need to be made of a transparent material, as long as a portion corresponding to a light path where light from the lens unit 42 passes through is made of a transparent material. The area other than the light path of the optical capsule 55 may be non-transparent (for example, black). With this, it is possible to prevent unwanted light, in other words, stray light from entering the image capturing element 31.

The supporting ring 52 has a circular ring shape, and provided with a first ring 52a, a second ring 52b, and a third ring 52c. The first ring 52a is provided in the central portion in the axial direction of the supporting ring 52 and holds the optical member 51 on the inner peripheral side thereof. The second ring 52b is fixed to the upper end surface of the first ring 52a with an adhesive. The third ring 52c is fixed to the lower end surface of the first ring 52a with an adhesive. The first ring 52a has a rectangular cross section. The second ring 52b and the third ring 52c each have a circular plate shape with a same radius and width as those of the first ring 52a, and are concentrically fixed to the first ring 52a. Accordingly, the supporting ring 52 has a circular ring shape having a rectangular cross section.

Each of the first ring 52a, the second ring 52b, and the third ring 52c is a plastic magnet made of e.g. polyphenylene sulfide (PPS) resin in which minute magnetic particles are dispersed and mixed. With this, water absorption and swelling can be prevented even in the liquid 56 that contains water. Also, by using the same resin material for both the plastic magnet and a binder, it is possible to fix the second ring 52b and the third ring 52c onto the first ring 52a with an adhesive having a high adhesion property to both members to be fixed, thereby making it possible to improve dependability for long-term use. Similarly, with the same material being used for the optical member 51 and the binder of the first ring 52a, it is possible to increase the adhesion property when the optical member 51 and the supporting ring 52 are fixed to each other, thereby making it possible to improve the long-term use and dependability.

Herein, neodymium is used as the magnetic particles of the first ring 52a, the second ring 52b, and the third ring 52c. Neodymium has an extremely large magnetic force and provides large driving torque, therefore it is effective when the viscosity of the liquid 56 is large at low temperature. However, since neodymium becomes oxidized by water and generates rust, the surface of the supporting ring 52 is coated with a resin material in order to prevent the supporting ring 52 from contacting the liquid 56. The coating with the resin material may be applied before or after the second ring 52b and the third ring 52c are fixed to the first ring 52a.

The liquid 56 that fills the optical capsule 55 is not limited to an anti-freeze solution. It is possible to fill the optical capsule 55 with another fluid, such as water, for example, as long as the fluid has a higher refractive index than that of the air and a lower refractive index than that of the parallel plate 57. Also, the anti-freeze solution does not need to be water-based. For example, transparent silicone oil may be employed. Because there is no likelihood that rust will occur in the supporting ring 52 or the like when transparent silicone oil is employed, an anti-rust treatment such as a resin coating or the like is not necessary.

The material of binder used for the first ring 52a, the second ring 52b, and the third ring 52c is not limited to PPS, and for example, a polyamide resin such as 6-nylon, a polyethylene resin, polypropylene resin, or the like may be used. Also, a different type of resin may be used for each of the first ring 52a, the second ring 52b, and the third ring 52c. On the other hand, the magnetic particles used for the first ring 52a, the second ring 52b, and the third ring 52c are not limited to neodymium, and it is possible to use, for example, ferrite, samarium cobalt, or the like. Also, different types of magnetic particles may be used for each of the first ring 52a, the second ring 52b, and the third ring 52c. When ferrite is used as the magnetic particles, the resin coating or the like mentioned above is not necessary since there is no likelihood of rusting.

The rotational driving device 54 is provided with a first magnetizer 61, a second magnetizer 62, a third magnetizer 63, a magnetic rotation driver 64, a first electromagnet (first position controller) 67, a second electromagnet (second position controller) 68, and a permanent magnet 69. The first magnetizer 61 is provided to the supporting ring 52 so as to face an outer peripheral thereof in the radial direction. The second magnetizer 62 is provided to the supporting ring 52 so as to face an upper end thereof in the axial direction. The third magnetizer 63 is provided to the supporting ring 52 so as to face a lower end thereof in the axial direction. The magnetic rotation driver 64 rotates the rotation body 53 by applying a magnetic force in the rotation direction onto the first magnetizer 61. The first electromagnet 67 controls a position of the rotation body 53 in the radial direction by applying a magnetic force in the radial direction to the first magnetizer 61. The second electromagnet 68 controls a position of the rotation body 53 in the axial direction by applying a magnetic force in the axial direction to the second magnetizer 62. The permanent magnet 69 applies a magnetic force in a same direction as the second electromagnet 68 to the third magnetizer 63 so as to maintain the rotation body 53 at a predetermined position in the axial direction.

The rotational driving device 54 is further provided with a first magnetic sensor 65 and a second magnetic sensor 66. The first magnetic sensor 65 detects a position of the rotation body 53 in the radial direction based on magnetism of the first magnetizer 61. The second magnetic sensor 66 detects a position of the rotation body 53 in the axial direction based on magnetism of the second magnetizer 62. The first electromagnet 67 controls a position of the rotation body 53 in the radial direction based on a detection result from the first magnetic sensor 65. The second electromagnet 68 controls a position of the rotation body 53 in the axial direction based on a detection result from the second magnetic sensor 66.

More specifically, the first magnetizer 61 is magnetized on the outer peripheral side of the first ring 52a in a polar anisotropy orientation so as to face the central portion, except both ends in the axial direction, of an outer peripheral surface of the first ring 52a. With this, the first ring 52a becomes a permanent magnet.

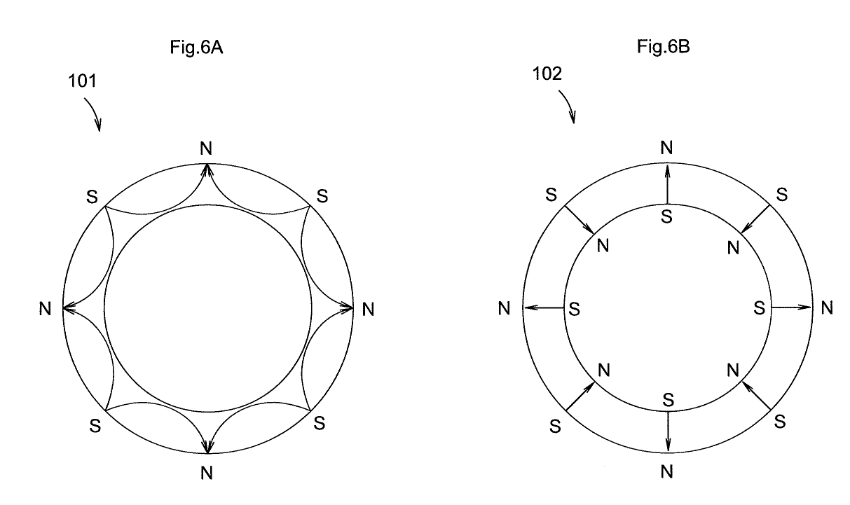

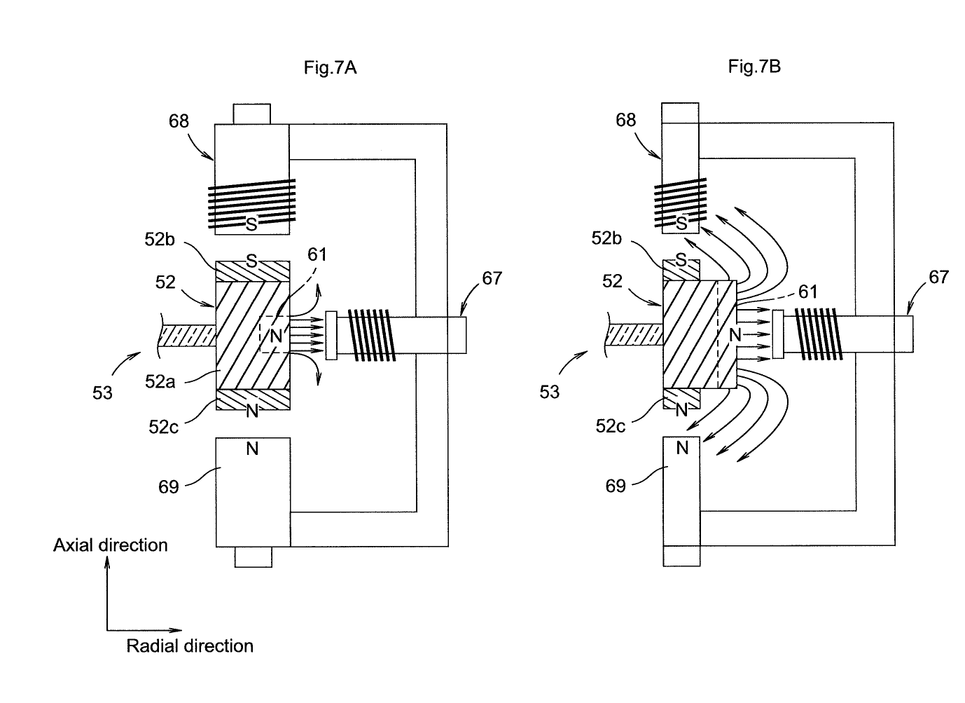

Hereafter, the polar anisotropic orientation will be described with reference to FIGS. 6A to 7B. FIGS. 6A and 6B illustrate orientations of easy axis of magnetization in anisotropic magnets. FIG. 6A is a plan view showing a polar anisotropic ring magnet 101. FIG. 6B is a plan view showing a radially anisotropic ring magnet 102. FIGS. 7A and 7B are sectional views schematically showing a main portion of the rotation body 53 and a magnetic force when the first ring 52a is magnetized in an anisotropic orientation. FIG. 7A shows a state of a magnetization in a polar anisotropic orientation. FIG. 7B shows a state of a hypothetical magnetization in a radially anisotropic orientation for comparison purposes.

In the polar anisotropic ring magnet 101, as shown in FIG. 6A, an oriented magnetic field is formed along a circumferential direction of a ring-shaped magnetic member so that the necessary number of poles (eight poles, in this example) are formed. By aligning an magnetic easy axis of magnetic particles with directions of magnetic lines shown in the arrows in FIG. 6A at the same time that the ring-shaped magnetic member is shaped to form a plastic magnet, the polar anisotropic ring magnet 101 is magnetized so as to form a plurality of magnetic pole pairs (four pairs, in this example) having a north pole and a south pole alternately appearing along the circumferential direction only on an outer peripheral surface without forming magnetic poles on an inner peripheral surface.

On the other hand, in the radially anisotropic ring magnet 102, as shown in FIG. 6B, an oriented magnetic field in the radial direction of the ring-shaped magnetic member is formed while reversely alternating directions along a circumferential direction of the ring-shaped magnetic member. By aligning a magnetic easy axis of magnetic particles with directions of magnetic lines at the same time that the ring-shaped magnetic member is shaped, the radially anisotropic ring magnet 102 is magnetized so as to form eight pairs of magnetic poles in total on the inner and outer peripheral surfaces, along a circumferential direction, each pair of magnetic north and south poles alternately reversing directions along the circumferential direction so as to repeat four times on the inner and outer peripheral surfaces.

Consequently, in the polar anisotropic ring magnet 101, the magnetic force generated by north poles and south poles on the outer peripheral surface is strong. In other words, a magnetic flux density becomes high, on an outer side in the radial direction of the ring-shaped magnet, while the magnetic force is weak on an axial direction side of the ring-shaped magnet. On the other hand, in the radially anisotropic ring magnet 102, the magnetic force generated by north poles and south poles on the outer peripheral surface is stronger on an inner side in the radial direction and on an axial direction side of the ring-shaped magnet than that of the polar anisotropic magnet, while the magnetic force is weaker on an outer side in the radial direction of the ring-shaped magnet than that of the polar anisotropic magnet.

In sum, as shown in the hypothetical configuration of FIG. 7B, when the first magnetizer 61 is magnetized in the radially anisotropic orientation, for example, magnetic lines generated at proximities of upper and lower ends of the first magnetizer 61 are vertically directed and cannot be applied to the first electromagnet 67, thereby losing a great amount of a magnetic force. On the other hand, as shown in FIG. 7A, when the first ring 52a is magnetized in the polar anisotropic orientation, a magnetic force generated by the first magnetizer 61 is generated in substantially horizontal direction on an outer side in the radial direction, thereby making it possible to apply most of the magnetic force to the first electromagnet 67. Accordingly, it is possible to increase a magnet force of the first electromagnet 67 applied to the first magnetizer 61 in order to control a position of the rotation body 53 in the radial direction, thereby making it possible to control the rotation body 53 in the radial direction with improved accuracy.

In the radially anisotropic ring magnet 102, with respect to a displacement in the circumferential direction (rotation of the rotation body 53), a surface magnetic flux density on the outer peripheral surface of the ring-shaped magnet changes by a large amount around a border of a north pole and a south pole, and changes by a small amount in other areas. On the other hand, in the polar anisotropic ring magnet 101, a surface magnetic flux density on the outer peripheral surface of the ring-shaped magnet sinusoidally changes with respect to a displacement in the circumferential direction, thereby making it possible to detect a rotation angle of the rotation body 53 with high accuracy and to control a rotational driving of the rotation body 53 with high accuracy.

Incidentally, an integral molding maybe made by configuring an inner diameter of the first ring 52a smaller than an outer diameter of the optical member 51, and placing the optical member 51 in a mold when the first ring 52a is formed. With this, it becomes possible to reduce a likelihood that the optical member 51 will be separated from the supporting ring 52 due to deterioration of an adhesive or the like, thereby improving a long-term dependability.

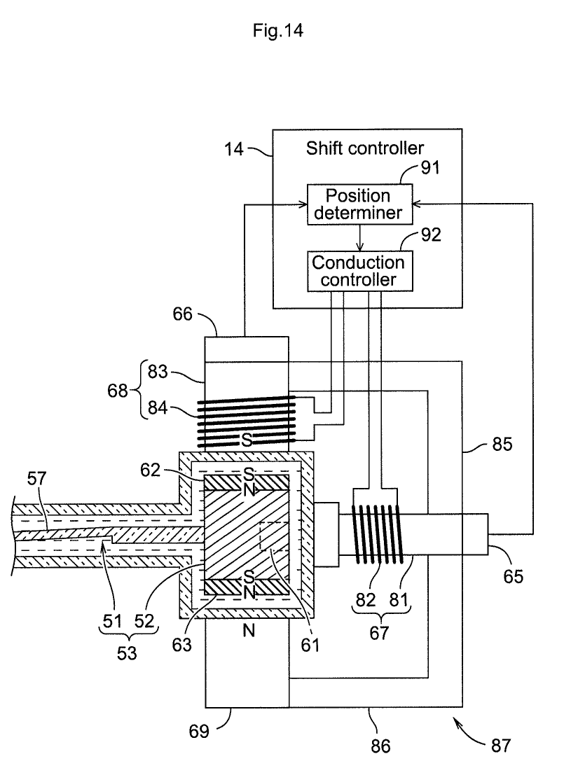

The second magnetizer 62 and the third magnetizer 63 form an oriented magnetic field in a vertical direction. By aligning a magnetic easy axis of magnetic particles at the time of shaping the ring-shaped magnetic member (plastic magnet), magnetization in an anisotropic orientation is made with the entire upper surfaces of the second ring 52b and the third ring 52c being magnetized with south poles, and the lower surfaces thereof being magnetized with north poles (see FIG. 14), thereby making the second ring 52b and the third ring 52c permanent magnets.

By configuring the supporting ring 52 as described above, an unmagnetized portion exists between the first magnetizer 61, and the second and third magnetizers 62 and 63 so as to act as a back yoke that easily becomes or provides a magnetic path. As stated earlier, while the second ring 52b and the third ring 52c have a uniform distribution of magnetic flux density in the circumferential direction, the first magnetizer 61 has a distribution of magnetic flux density that sinusoidally changes in the circumferential direction. Therefore, the accuracy of controlling the displacement of the rotation body 53 in the axial direction is decreased when a magnetic field of the first magnetizer 61 affects the second magnetizer 62 and the third magnetizer 63. However, with the unmagnetized portion existing between the first magnetizer 61, and the second and third magnetizers 62 and 63, it becomes unlikely for the magnetic field of the magnetizer 61 to impact the second magnetizer 62 and the third magnetizer 63, thereby making it possible to highly accurately control the displacement of the rotation body 53 in the axial direction.

Further, by having the unmagnetized portion between the first magnetizer 61, and the second and third magnetizers 62 and 63, it is possible to extend each of the second magnetizer 62 and the third magnetizer 63 to the respective outer peripheral edges of the second ring 52b and the third ring 52c while avoiding interference of the magnetic force of the first magnetizer 61. With this, the second magnetizer 62 and the third magnetizer 63 can be configured to have strong magnetic force, thereby improving accuracy in controlling a displacement of the rotation body 53 in the axial direction by the second electromagnet 68 and the permanent magnet 69. Further, in this configuration, because each of the first magnetizer 61, the second magnetizer 62, and the third magnetizer 63 may be separately disposed on each of the first ring 52a, the second ring 52b, and the third ring 52c, magnetization is easily obtained, and also the magnetic field can be increased at the time of magnetization so that the magnetic force of each of the first magnetizer 61, the second magnetizer 62, and the third magnetizer 63 is maximized. Consequently, it is possible to improve an accuracy of a displacement control in the radial and axial directions of the rotation body 53.

In this configuration of the rotation body of 53, the supporting ring 52 that is configured as a portion of the rotational driving device 54 is directly connected to the optical member 51 without employing another member, such as a back yoke. Therefore, it is possible to reduce adhered areas in the rotation body 53 as well as the size of the optical capsule 55, thereby making it possible to reduce the size of the image capturing device 1.

Also, the rotation body 53 is simply configured by disposing the first ring 52a, the second ring 52b, and the third ring 52c onto the optical member 51. Because no conducting wire needs to be introduced into the optical capsule 55, it is possible to improve the sealing property of the optical capsule 55. Also, increased independency of the optical capsule 55 as a member is beneficial in a production process.

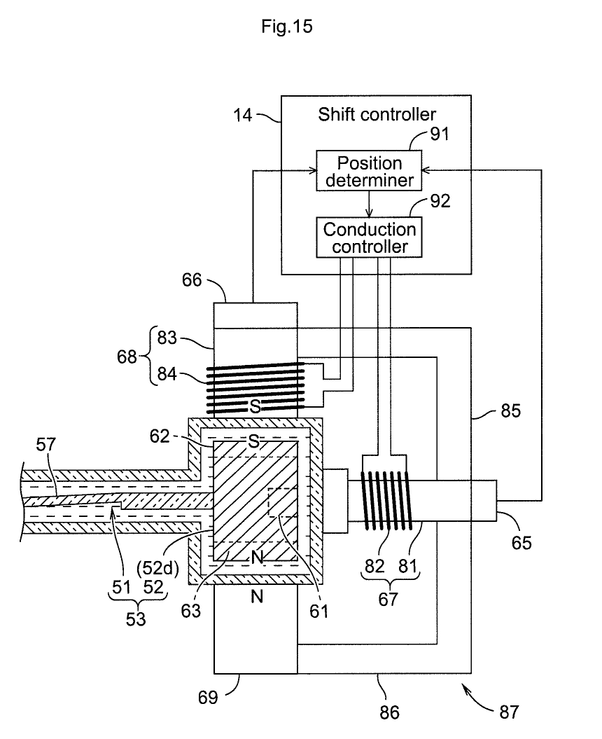

FIG. 15 is a cross-sectional view showing a main portion of a first variation of the rotational driving device, which corresponds to FIG. 14 (a main portion of FIG. 5). Only elements different from FIG. 14 are described hereafter. In FIG. 15, configuration components similar to FIG. 14 are provided with the same numerical references, and description of illustration thereof is omitted.

In the image capturing device 1, as shown in FIG. 15, the supporting ring 52 is configured with a single ring 52d that has an annular ring shape and holds the optical member 51 on the inner circumferential side. In the rotational driving device 54, the first magnetizer 61 is provided to the single ring 52d so as to face the outer peripheral surface thereof in the radial direction; the second magnetizer 62 is provided to the single ring 52d so as to face the upper end thereof in the axial direction; and the third magnetizer 63 is provided to the single ring 52d so as to face the lower end thereof in the axial direction. The first magnetizer 61 magnetizes the outer circumferential side of the ring 52d in the polar anisotropic orientation at the center portion of the outer peripheral surface while having an unmagnetized portion remain between the second magnetizer 62 and the third magnetizer 63.

In the image capturing device 1 in FIGS. 5 and 14, the supporting ring 52 is configured with the first ring 52a, the second ring 52b, and the third ring 52c, and thus the second ring 52b and the third ring 52c need to be adhered to the first ring 52a. By contrast, when the supporting ring 52 is formed of the single ring 52d as described in the first variation, it is possible to reduce a likelihood that the rings will be separated due to deterioration of an adhesive or the like, thereby improving the long-term use dependability.

The magnetic rotation driver 64 is provided with a stator core 71 that is configured with multilayer of electromagnetic steel laminations, and the a coil 72 that is wound around the stator core 71 as shown in FIG. 8. The stator core 71 abuts the outer peripheral surface of the optical capsule 55, and is disposed so as to face the first magnetizer 61 with the optical capsule 55 in between.

The rotational driving device 54 is an inner-rotor type three-phase motor. As shown in FIG. 9A, the first magnetizer 61, which is a magnetic field system, has eight magnetic poles that are alternately magnetized to be a north pole or a south pole along the circumferential direction. Three magnetic rotation drivers 64 are provided at equal distance from one another. Two teeth 73 are provided on each stator core 71. As shown in FIG. 9B, the rotational driving device 54 is configured to have six stators and eight poles. This configuration is attained by removing three equally-spaced stator cores, each of which has two teeth, from the conventional three-phase motor having twelve stators and eight poles.

The coil 72 of the magnetic rotation driver 64 is connected in a star connection (see FIG. 12). A pair of the coils 72 in each stator core 71 is set to be two phases out of three phases (u-phase, v-phase, and w-phase). More specifically, the pair is set to be either u-phase and v-phase, v-phase and w-phase, or w-phase and u-phase.

When the coil 72 of the magnetic rotation driver 64 is made to conduct, so as to excite the magnetic rotation driver 64, attractive and repulsive forces are generated between the first magnetizer 61 and the magnetic rotation driver 64, thereby making it possible to drive the rotation body 53 without contacting the rotation body 53 in the optical capsule 55. This configuration, which employs a magnetic force, is similar to the configuration of a bearingless motor. With this, it is possible to eliminate a sliding member, to drive the rotational driving device 54 with extremely small vibration, and to attain a long operating life.

As shown in FIG. 12, the coil 72 in the magnetic rotation driver 64 is driven by a three-phase driver 75 provided in the shift controller 14. In the shift controller 14, a speed command value is transmitted from a calculation processor 76 to a pulse width modulator (PWM) 77. The pulse width modulator 77 calculates on-duty ratio based on the speed command value, and outputs the PWM signal to the three-phase driver 75 after performing a pulse width modulation based on the duty ratio. The three-phase driver 75 is internally provided with a three-system push-pull type transistor circuit 78, and controls the current in each coil 72 based on the PWM signal. Thereby, the rotation drive 53 is rotationally driven at the circular motion period indicated by the period setter 25 (see FIG. 2).

As shown in FIG. 4, the first electromagnet 67 is provided with a first magnetic body 81 that opposes the first magnetizer 61, and a coil 82 that is wound around the first magnetic body 81. The first magnetic body 81 is configured as multilayer electromagnetic steel laminations in order to suppress an overcurrent, and abuts the outer peripheral surface of the optical capsule 55.

When the coil 82 of the first electromagnet 67 is made conductive so as to excite the first electromagnet 67, attractive and repulsive forces are generated between the first magnetizer 61 and the first electromagnet 67. Three first electromagnets 67 are provided around the optical capsule 55 at equal distance from one another (see FIG. 8). A magnetic force in radial direction applied to the rotation body 53 is adjusted by separately controlling a conduction amount of each coil 82 in the first electromagnet 67, thereby making it possible to displace the rotation body 53 in the radial direction. In this way, the rotation body 53 is held at the predetermined position in the radial direction, in other words, at the position in the radial direction where the center axis of the optical member 51 is substantially aligned with the optical axis C.

The second electromagnet 68 is provided with a second magnetic body 83 opposes the second magnetizer 62, and a coil 84 that is wound around the second magnetic body 83. The second magnetic body 83 is configured as multilayer electromagnetic steel laminations in order to suppress an overcurrent, and abuts a top outer surface of the optical capsule 55.

The permanent magnet 69 is provided on the side opposite to the second electromagnet 68 with the optical capsule 55 in between. The permanent magnet 69 abuts the bottom outer surface of the optical capsule 55, and opposes the third magnetizer 63 with the optical capsule 55 in between.

The permanent magnet 69 and the third magnetizer 63 are provided in a state where mutually opposing sides thereof have a same magnetic pole (a north pole, in this example, see FIGS. 13, 14, and 15) so that repulsive force is generated between the permanent magnet 69 and the third magnetizer 63, thereby holing the rotation body 53 in a floating state spaced apart from the inner bottom surface of the optical capsule 55.

The second electromagnet 68 and the second magnetizer 62 are provided in a state where mutually opposing sides thereof have a same magnetic pole (a south pole, in this example, see FIGS. 13, 14, and 15). When the coil 84 of the second electromagnet 68 is made conductive so as to excite the second electromagnet 68, repulsive force is generated between the second electromagnet 68 and the second magnetizer 62.

Three second electromagnets 68 are provided on a surface of the optical capsule 55 at an equal distance from one another (see FIG. 8). Three permanent magnets 69 are provided on the other surface of the optical capsule 55 at an equal distance from one another in the same circumferential direction as that of the second electromagnet 68 (so as to overlap in the optical axis direction). By controlling conduction amount of each coil 84 of the second electromagnet 68, repulsive force generated between the second electromagnet 68 and the second magnetizer 62 is balanced with the repulsive force generated between the permanent magnet 69 and the third magnetizer 63, thereby sustaining the rotation body 53 at a predetermined position in the axial direction.

As described above, since the second electromagnet 68 and the permanent magnet 69 act together to control the displacement of the rotation body 53 in the axial direction, it is possible to control the displacement of the rotation body 53 in the axial direction with ease and high accuracy. Herein, by equally controlling the conduction amount of each coil 84 of the second electromagnet 68, it is possible to displace the rotation body 53 in the axial direction to a position where the repulsive forces of the second electromagnet 68 and the permanent magnet 69 are balanced. On the other hand, by separately controlling the conduction amount of each coil 84 of the second electromagnet 68, it is also possible to control the rotation body 53 so as to suppress a swinging motion having the center line of the rotation body 53 inclined with respect to the optical axis C. By configuring the structure in this way, it is possible to properly control an optical shift amount, even when the lens unit 42 is configured as a zoom lens, for example.

Further, it is also possible to form a configuration that generates and balances attracting forces between the second electromagnet 68 and the second magnetizer 62, and between the permanent magnet 69 and the third magnetizer 63. Particularly in the above-described configuration that generates a repulsive force, even when the second electromagnet 68 is not excited, the rotation body 53 achieves a floating state that is spaced apart from the inner bottom surface of the optical capsule 55 due to magnetism of the permanent magnet 69, thereby providing an advantage that the rotation body 53 can start rotating smoothly at the time of a start-up.

Incidentally, it is preferable to employ a neodymium magnet for the permanent magnet 69. However, another type of magnet, for example, ferrite magnet, or the like may be used with consideration of a balance with the magnetism of the second electromagnet 68 disposed above the permanent magnet.

The first magnetic sensor 65 may be made of a Hall element, for example. The first magnetic sensor 65 is disposed at an end on a side opposite to the first magnetizer 61 in the first magnetic body 81 that configures the first electromagnet 67. The first magnetic sensor 65 and the first electromagnet 67 are integrated by fixing the first magnetic sensor 65 onto a surface of the first magnetic body 81.

When the first magnetic sensor 65 is disposed as described above, the first magnetic sensor 65 overlaps the first electromagnet 67 in the radial direction, thereby reducing a space necessary for the configuration. The first magnetic sensor 65 detects magnetism of the first magnetizer 61 through the first magnetic body 81. In other words, the magnetism of the first magnetizer 61 is guided by the first magnetic body 81 to the first magnetic sensor 65, thereby making it possible to maintain high detection accuracy of the first magnetic sensor 65.

The second magnetic sensor 66 may be made of a Hall element, for example, and is disposed at an end on a side opposite to the second magnetizer 62 in the second magnetic body 83 that configures the second electromagnet 68. The second magnetic sensor 66 and the second electromagnet 68 are integrated by fixing the second magnetic sensor 66 onto a surface of the second magnetic body 83.

When the second magnetic sensor 66 is disposed as described above, the second magnetic sensor 66 overlaps the second electromagnet 68 in the axial direction, thereby reducing a space necessary for the configuration. The second magnetic sensor 66 detects magnetism of the second magnetizer 62 through the second magnetic body 83. In other words, magnetism of the second magnetizer 62 is guided by the second magnetic body 83 to the second magnetic sensor 66, thereby making it possible to maintain a high detection accuracy of the second magnetic sensor 66.

While a space reduction is an advantage in the above-descried configuration, in which magnetism is guided by a magnetic body and detected by a magnetic sensor, magnetism attenuates while passing through the magnetic body. Attenuation of magnetism occurs depending on several factors such as an absolute intensity of magnetism of a measured object (magnetism generated by the first magnetizer 61, for example), length and magnetic permeability of a magnetic body that guides the magnetism, a gap length between a detected object (the first magnetizer 61, for example) and a magnetic body, and the like. Therefore, generally, when a magnetic sensor lacks accuracy in detection as a result, output of a magnetic sensor can be improved by placing a block of a magnetic body (not shown) at a further outer side of the magnetic sensor (a further outer circumferential side of the first magnetic sensor 65 disposed on the outer circumferential side of the first electrode 67, for example). This is because magnetic lines passing through a magnetic sensor are increased by use of the magnetic body block. It is also effective to use a GMR (Giant Magneto Resistive) element as a magnetic sensor instead of the Hall element. The GMR element is originally used for a magnetic head of a hard disk drive and is known for having the capability of dramatically increasing memory capacity. By using a GMR element, it is possible to detect feeble (i.e., low level) magnetism with high accuracy.

The first magnetic body 81 that configures the first electromagnet 67 is connected to the second magnetic body 83 that configures the second electromagnet 68, through a connector 85. The first magnetic body 81 that configures the first electromagnet 67 is connected to the permanent magnet 69 through a connector 86. In this way, a position detection and control unit 87 is integrally configured with the first magnetic sensor 65, the second magnetic sensor 66, the first electromagnet 67, the second electromagnet 68, and the permanent magnet 69.

It is preferable that the connector 85 and the connector 86 are made of a non-magnetic material (a resin, a ceramic, or the like, for example). With this, it is possible to prevent a magnetic mutual interaction from occurring among the first electromagnet 67, the second electromagnet 68, and the permanent magnet 69.

As shown in FIG. 8, the position detection and control unit 87 is provided between the magnetic rotation drivers 64 that are provided in the circumferential direction, each position detection and control unit 87 being spaced an equal distance from each other position detection and control unit 87. Three magnetic rotation drivers 64 are provided at an angle of 120 degree between one another with respect to the center of the optical capsule 55, which is the center of the regularly-positioned rotation body 53. Three position detection and control units 87 are also provided at an angle of 120 degree between one another with respect to the center of the optical capsule 55. As shown in FIG. 9B, this configuration is attained by removing three equally-spaced stator cores, each of which having two teeth, from the conventional three-phase motor having twelve stators and eight poles, and then by placing the position detection and control units 87 in the spaces vacated by the stator cores, as shown in FIG. 9A.

As described above, the first magnetic sensor 65, the second magnetic sensor 66, the first electromagnet 67, the second electromagnet 68, and the permanent magnet 69 are integrated by being provided at a same position in the circumferential direction, and placed in the space between magnetic rotation drivers 64, therefore it is possible to effectively use the space outside the optical capsule 55, and thus saving space.

The stator core 71 that configures the magnetic rotation driver 64, the first magnetic body 81 that configures the first electromagnet 67, and the second magnetic body 83 that configures the second electromagnet 68, and the permanent magnet 69 abut the outer surface of the optical capsule 55. Therefore, when dimensions of the optical capsule 55 are accurately kept, it is possible to determine positions of each component with extreme accuracy, thereby realizing a high control capability.

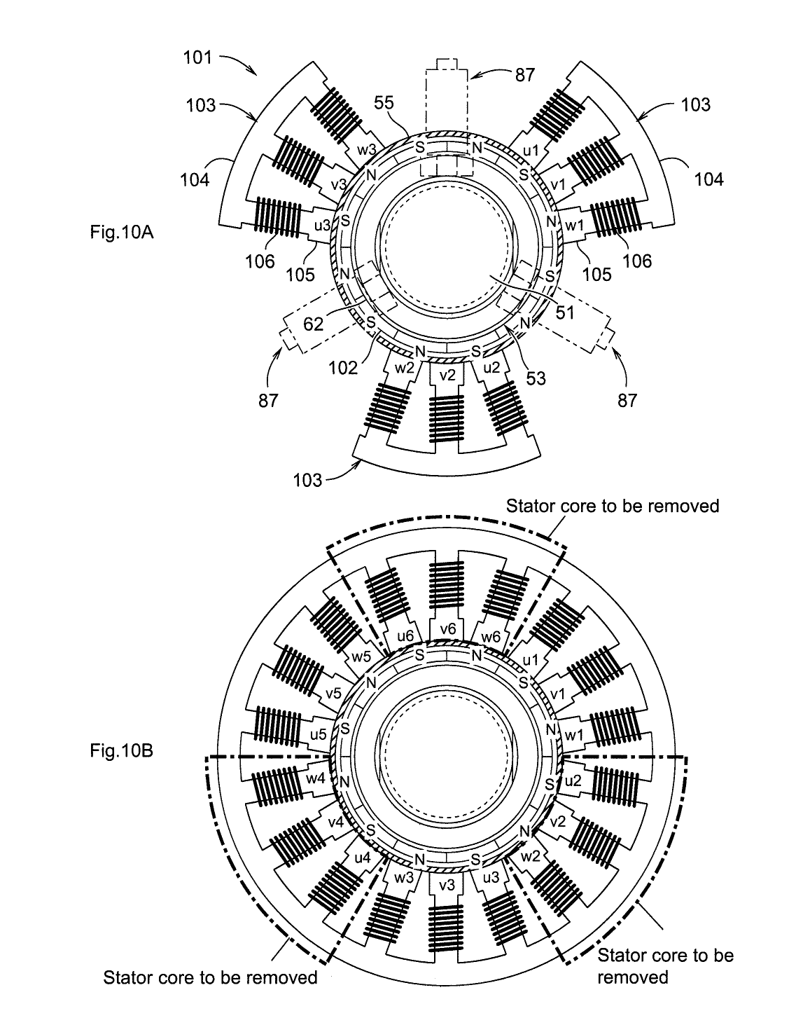

FIG. 10A is a plan view showing a rotational driving device according to a second variation. FIG. 10B is a horizontal sectional view showing one example of applying a conventional configuration of a rotational driving device having a three-phase motor, which is used as a base of the rotational driving device in FIG. 10A. In FIGS. 10A and 10B, only points different from the previous examples are illustrated. Configuration components similar to the previous examples are provided with the same numerical references, and description or illustration thereof is omitted.

As shown in FIG. 10A, in a rotational driving device 101, a first magnetizer 102, which is a magnetic field system, has 12 magnetic poles alternately magnetized into a north pole or a south pole along the circumferential direction. Further, three magnetic rotation drivers 103 are disposed at an equal distance from one another. Each stator core 104 has three teeth 105. As shown in FIG. 10B, this configuration of the rotational driving device 101 is attained by removing three equally-spaced stator cores having three teeth from the conventional three-phase motor that has twelve stators and eight poles, and then by placing the position detection and control units 87 in the spaces vacated by the stator cores, the position detection and control units 87 being integrally configured with the first magnetic sensor 65, the second magnetic sensor 66, the first electromagnet 67, the second electromagnet 68, and the permanent magnet 69.

A coil 106 is provided to each of three teeth 105 of the stator core 104, and is connected in a star connection. Three coils 106 provided to each stator core 104 are set to be either u-phase, v-phase, or w-phase.

As shown in FIG. 9A, the rotational driving device 54 according to the previous example is configured to have the stator core 71 having two teeth. In this case, for example, when u-phase and v-phase coils 72 are conducted, the teeth 73 having a w-phase coil 72, which is not supposed to be excited, is also excited and acts to suppress a rotation of the rotation body 53, thereby reducing a motor efficiency due to an energy loss. On the other hand, because the stator core 104 according to the present embodiment is configured to have three teeth such that u-phase, v-phase and w-phase are all present on each stator core 104, there is no braking timing, thereby improving a motor efficiency.

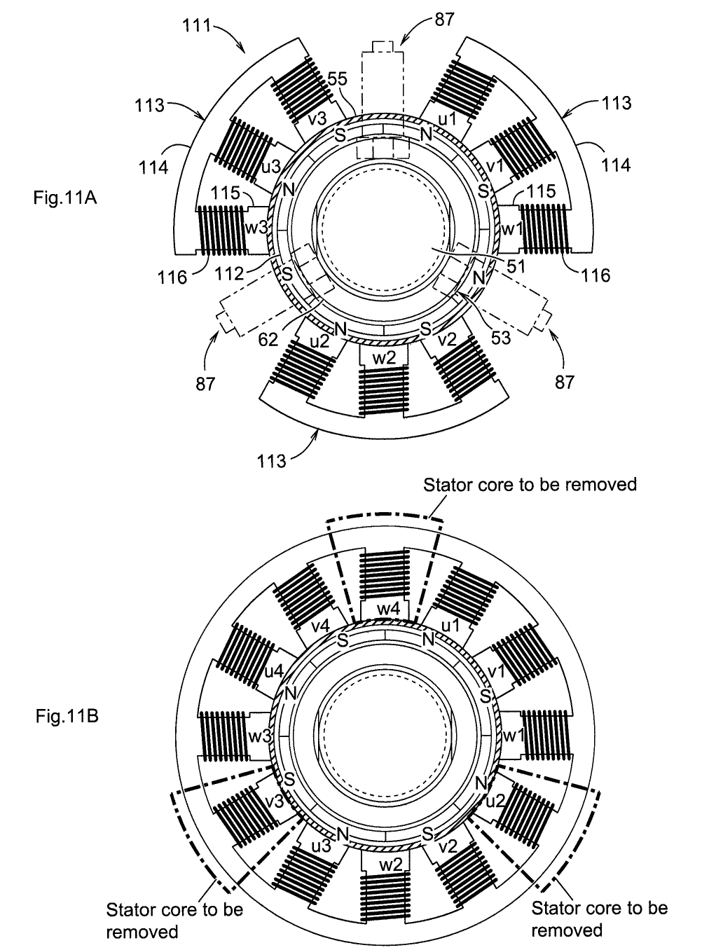

FIG. 11A is a plan view showing a rotational driving device according to a third variation. FIG. 11B is a plan view showing one example of applying a conventional configuration of a rotational driving device having a three-phase motor, which is used as a base of the rotational driving device in FIG. 11A. In FIGS. 11A and 11B, only points different from the previous examples are illustrated. Configuration components similar to the previous examples are provided with the same numerical references, and description or illustration thereof is omitted.

As show in FIGS. 11A, in a rotational driving device 111, a first magnetizer 112, which is a magnetic field system, has eight magnetic poles alternately magnetized into a north pole or a south pole along the circumferential direction. Further, three magnetic rotation drivers 113 are disposed at an equal distance from one another. Each stator core 114 has three teeth 115. As shown in FIG. 11B, this configuration of the rotational driving device 111 is attained by removing three equally-spaced stator cores each having one tooth from the conventional three-phase motor that has twelve stators and eight poles, and then by placing the position detection and control units 87 in the spaces vacated by the stator cores, the position detection and control units 87 being integrally configured with the first magnetic sensor 65, the second magnetic sensor 66, the first electromagnet 67, the second electromagnet 68, and the permanent magnet 69.

A coil 116 is provided to each of three teeth 115 of the stator core 114, and is connected in a star connection. Three coils 116 on each stator core 114 are set to be either u-phase, v-phase, or w-phase.

As shown in FIG. 10A, in the rotational driving device 101 according to the second variation, the stator core 104 is configured to have three teeth, therefore spaces between each teeth 105 are limited, thereby making it difficult to wind the coil 106. On the other hand, in the third variation, even though there are nine stators as in the second variation, it is possible to keep larger spaces between each teeth 115 compared to the second variation without enlarging the outer peripheral of the stator core 114. Therefore, it is easy to wind the coil 116, thereby improving efficiency in production while saving space. Further, with increased areas in the proximity of the edge of the teeth 115 that oppose the first magnetizer 112, it is possible to provide a rotational driving with improved stability.

As shown in FIG. 13, the shift controller 14 is provided with a position determiner 91 and a conduction controller 92. The position determiner 91 determines a position of the rotation body 53 in the radial and axial directions based on a signal output from the first magnetic sensor 65 and the second magnetic sensor 66. The conduction controller 92 controls a conduction amount of the coil 82 and the coil 84, each of which is provided to the first electromagnet 67 and the second electromagnet 68 respectively, based on the determination result of the position determiner 91. The position determiner 91 and the conduction controller 92 are operated by executing a predetermined program in a CPU of the calculation processor 76 shown in FIG. 12.

The position determiner 91 determines a location of the rotation body 53 in the radial direction based on strength of magnetism of the first magnetizer 61 detected by the first magnetic sensor 65. The position determiner 91 further determines a location of the rotation body 53 in the axial direction based on strength of magnetism of the second magnetizer 62 detected by the second magnetic sensor 66.

The conduction controller 92 compares an actual position of the rotation body 53 determined by the position determiner 91 with a regular position thereof; and calculates an adjustment value for the radial and axial directions in order to correct a position of the rotation body 53 with respect to the regular position. As shown in FIG. 12, the adjustment value is transmitted from the calculation processor 76 to a first electromagnet driver 93 and a second electromagnet driver 94 through a D/A convertor (DAC) so as to apply a current corresponding to the adjustment value to the coil 82 of the first electromagnet 67 and the coil 84 of the second electromagnet 68. With such a feedback control, the rotation body 53 is maintained in a regular position in the radial and axial directions.

Herein, the first magnetic sensor 65 and the first electromagnet 67 are provided at a same position in the circumferential direction, therefore the position of the rotation body 53 in the radial direction detected by the first magnetic sensor 65 agrees with a position where the first electromagnet 67 applies a radial direction force to the rotation body 53. Also, the second magnetic sensor 66 and the second electromagnet 68 are provided at a same position in the circumferential direction, therefore the position of the rotation body 53 in the radial direction detected by the second magnetic sensor 66 agrees with a position where the second electromagnet 68 applies an axial direction force to the rotation body 53. In this way, it is possible to simplify a calculation process for position control and to control a position of the rotation body 53 with ease and high accuracy.

Further, in the shift controller 14, a position determination operation by the position determiner 91 and a position control operation by the conduction controller 92 are alternately performed through time sharing. In other words, while a position control operation is performed so as to render conductive the coil 82 of the first electromagnet 67 and the coil 84 of the second electromagnet 68, a position determination operation based on signals output from the first magnetic sensor 65 and the second magnetic sensor 66 is not performed. By contrast, while a position determination operation is performed, a position control operation is not performed.

In this way, it is possible to avoid a circumstance where the first magnetic sensor 65 and the second magnetic sensor 66 inaccurately detect magnetism of the first magnetizer 61 and the second magnetizer 62 due to an influence of magnetism generated by conduction of the coil 82 of the first electromagnet 67 and the coil 84 of the second electromagnet 68.

Incidentally, in a super-resolution processing performed in the super-resolution processor 24 shown in FIG. 2, it is possible to considerably reduce a calculation cost of a positioning process when an image capturing position of a base frame image is known. For example, when an image capturing element of 1.2 mega pixel is structured in a size of one-third inch, a pixel pitch becomes approximately 3.75 When enlarging the image with 4×4 magnification with a super-resolution, a pixel pitch of a newly generated image is 3.75/4=0.93 μm. Therefore, it is desirable to accurately determine the image capturing position in submicron order.

In order to determine an image capturing position of a frame image with high accuracy, first of all, it is necessary to control a position of the optical member 51 with high accuracy. As described above, a control of a displacement of the optical member 51 is realized by the first magnetic sensor 65, the second magnetic sensor 66, the first electromagnet 67, and the second electromagnet 68. Then, in order to determine the image capturing position of the frame image with high accuracy, it is necessary to highly accurately detect a rotation position of the rotation body 53 that defines a light shift direction by the parallel plate 57.

For that, as shown in FIG. 8, the rotational driving device 54 is provided with the origin sensor 70 that detects an original position, which is a reference position when the optical member 52 rotates. Based on a signal output from the origin sensor 70, a shift position is determined for an optical image captured by the image capturing element 31 in response to a timing signal generated by the driving circuit 33. With this, it is possible to determine an image capturing position of a frame image with high accuracy as well as to reduce a calculation cost of the super-resolution processing.

The origin sensor 70 is configured with a reflection-type photo sensor (photo reflector) and detects a marking (not shown) placed on the supporting ring 52 of the optical member 51. The marking may be formed on the surface of the supporting ring 52 by applying a paint in a desired color (for example, white if the supporting ring is black) by use of a printing method or the like. The origin sensor 70 is not limited to the reflection-type photo sensor and other known sensors, including an optical sensor, may be used.

In addition, in order to accurately determine an image capturing position of a frame image, it is necessary to accurately control a driving speed of the optical member 51. For that, first of all, it is necessary to detect a driving speed of the rotation body 53. Herein, the driving speed of the rotation body 53 is obtained based on a signal output from the first magnetic sensor 65. When the first magnetizer 61 rotationally drives along with the rotation body 53, a magnetic pole (a north pole and a south pole) opposing to the first magnetic sensor 65 is alternately switched. The signal output from the first magnetic sensor 65 has a sinusoidal wave shape, one cycle of which corresponds to a period where a pair of a north pole and a south pole on the first magnetizer 61 alternates. Based on the cycle of the output signal, it is possible to obtain the rotation speed of the rotation body 53.

The description above is more specifically described with reference to FIG. 12. The output signal of the first magnetic sensor 65 is binarized in a comparator (CMP) and output as a three-system FG pulse. A pulse interval of the FG pulse is measured by a high speed counter (not shown). The calculation processor 76 performs a calculation in that a known distance between poles in the first magnetizer 61 is divided by a value measured by the high speed counter, thereby obtaining an actual speed value Vn.

Further, instead of the above described method that detects a rotation speed, for example, an optical sensor (photo reflector) may be employed so as to detect a marking applied on the optical member 51, the first magnetizer 61, and the like. In this case, when the marking is made in black and white, it is possible to draw the marking with relatively narrow pitch, thereby making it possible to detect a rotation angle speed at a higher sampling rate.

Incidentally, in order to rotate the optical member 51 with a constant speed, herein a PI control (proportional integral control) is performed based on the rotation speed of the optical member 51. Specifically, first, a target speed value Vr is set in response to the circular motion period indicated by the period setter 25 (see FIG. 2), and then an error δV (=Vr−Vn), that is a discrepancy between the target speed value Vr and the actual speed value Vn, is calculated. The error δV is then multiplied by a proper gain Gp so as to calculate a proportional value (P=Gp×δV). Further, due to an occurrence of speed offset, the error δV is integrated and then multiplied by a proper gain Gi so as to calculate an integral value (I=Gi×Σ(δV)). Lastly, the speed command value is obtained by adding the above obtained proportional value (P) and integral value (I). As described earlier, the speed command value is sent to the pulse width modulator (PWM) so as to output a PWM signal that drives the three-phase driver 75. In this way, the optical member 51 can be rotated with a constant speed with high accuracy.

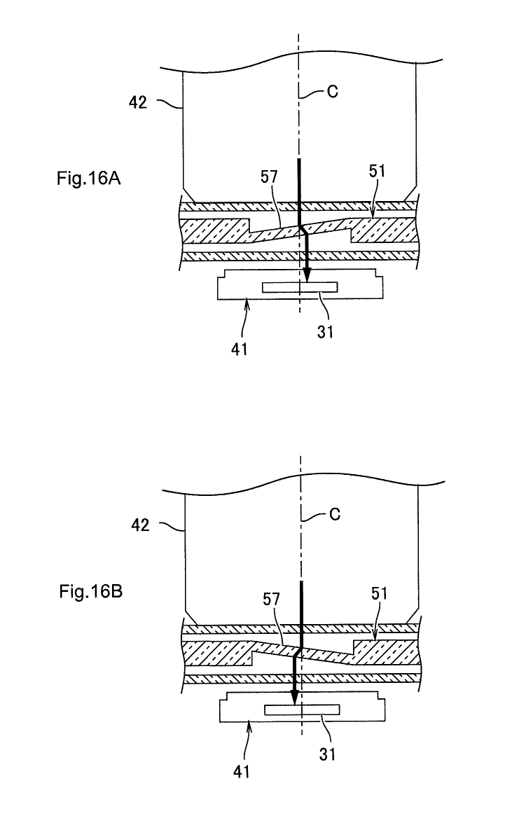

FIGS. 16A and 16B are cross-sectional views showing incidence statuses of light toward the image capturing element 31. FIG. 16A illustrates a state where a light pass of the incident light shifts toward the rightmost side. FIG. 16B illustrates a state where the parallel plate 57 is rotated by 180 degree from the state in FIG. 16A. Incidentally, when the parallel plate 57 is further rotated by 180 degree from the state in FIG. 16B, the state in FIG. 16A is recovered.

The parallel plate 57 in the optical member 51 is inclined with respect to the optical axis C of the lens unit 42 so as to refract the incident light incoming through the lens unit 42. Therefore, the position of the incident light on the light-receiving surface changes depending on the rotation position of the parallel plate 57. When the optical member 51 is rotated by the optical shift mechanism 35, the optical image formed on the light-receiving surface of the image capturing element 31 displaces so as to draw a circle at a cycle (circular motion period) responding to the rotation speed of the optical member 51. In this way, it is possible to slightly displace the optical image relative to the image capturing element 31.

As descried above, the parallel plate 57 has only a function that shifts the incident light passed through the lens unit 42 toward a direction perpendicular to the optical axis C. Further, because relative positions between the lens unit 42 and the image capturing element 31 are fixed, an angle of view on the side of the image capturing element 31 is accordingly determined. As apparent from the above description, the amount of optical shift remains unchanged regardless of whether the parallel plate 57 displaces parallel to the direction of the optical axis C or to the direction perpendicular to the optical axis C. On the other hand, a change in an angle between the parallel plate 57 and the optical axis C significantly affects the amount of optical shift. In other words, an angle change of the optical member 51 with respect to the optical axis C has a great deal of influence in controlling a displacement of the optical member 51 including the parallel plate 57. Ultimately, the parallel displacements of the optical member 51 in the direction along the optical axis C and in the direction perpendicular to the optical axis C (in the radial direction) are controlled so that the optical member 51 does not abut the internal surface of the optical capsule 55. As described above, herein, the magnetic rotation driver 64 from outside applies magnetism to the optical member 51, and in average the magnetism acts to align a rotation center of the optical member 51 with the optical axis C. Therefore, it is possible to omit the first electromagnet 67 and the first magnetic sensor 65 from the configuration described above. In this case, however, there is a possibility that the optical member 51 produces small oscillations. When such an oscillation in an image capturing device is not preferred, the first electromagnet 67 and the first magnetic sensor 65 should not be omitted.

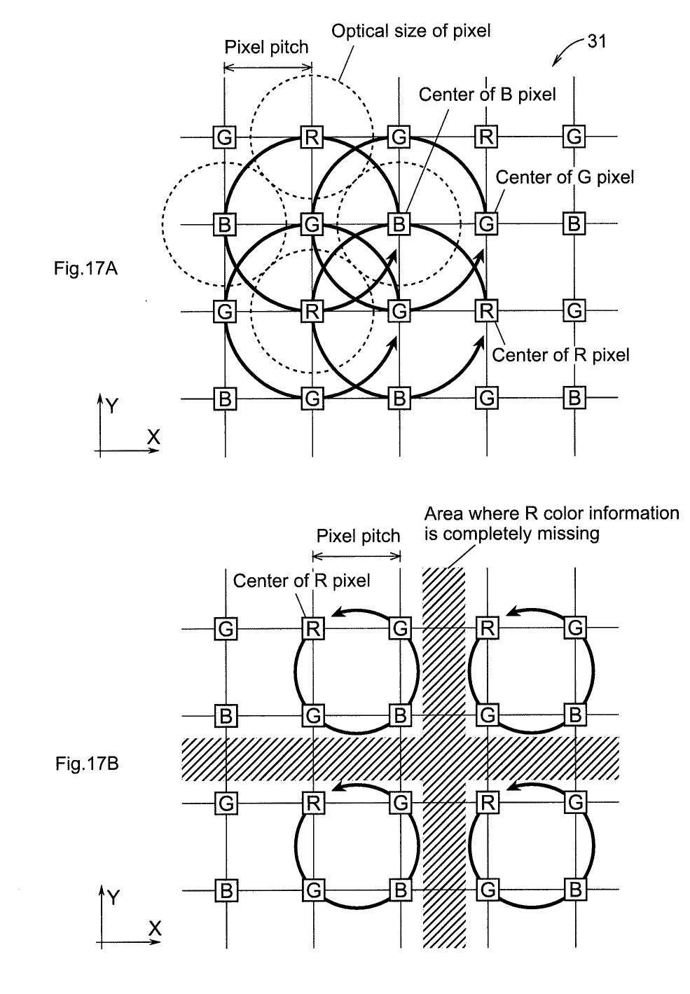

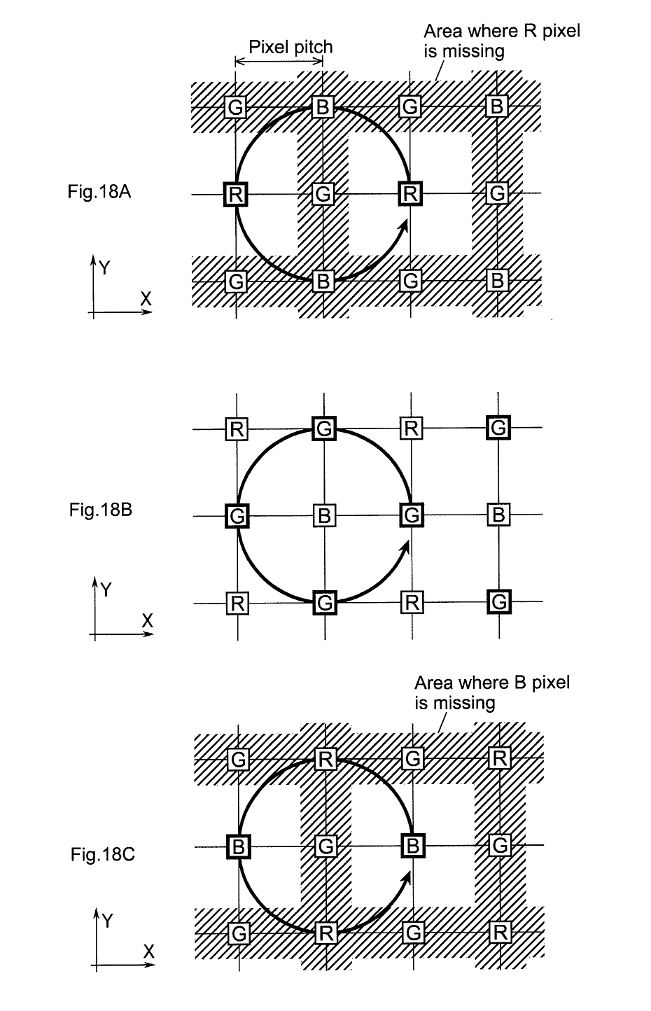

FIGS. 17A to 18C are schematic diagrams illustrating statuses of a relative circular motion of pixels relative to an optical image. The image capturing element 31 is a single-chip image capturing element that has R pixels, B pixels, and G pixels arranged based on the Bayer filter mosaic, R pixels receiving R (Red) components from the incoming light; B pixels receiving B (Blue) components from the incoming light; and G pixels receiving G (Green) components from the incoming light. In the Bayer filter mosaic, 50% of the total pixels are made of G pixels arranged in a checkered flag manner. R pixels and B pixels, each of which occupy 25% of the total pixels, are dispersedly provided in the areas where G pixels are not disposed. Hereafter, X-axis refers to a main scanning direction, and Y-axis refers to a vertical scanning direction.

As shown in FIGS. 16A and 16B, an optical image displaces with respect to a pixel of the fixed image capturing element 31. In the description hereafter, however, as a matter of convenience, a relative displacement of a pixel with respect to an optical image is shown as a displacement of a pixel with respect to a still optical image. Further, each pixel receives a range of light shown as substantially an optical size. However, in the description hereafter, as a matter of convenience, only a central position of each pixel is shown.

Herein, as shown in FIG. 17B, when a diameter of a circular motion is set to be square root of 2 times of the length of a pixel pitch, for example, there is an area (shown by shading) where color information of R is completely missing due to being out of the displacement area of R pixels. Similarly, there is an area where color information of B pixels is completely missing due to being out of the displacement area of B pixels. Incidentally, as in a conventional technology, when a diameter of a circular motion is set to be (square root of 2)/2 times of the length of a pixel pitch, there is even a larger area where R color information is completely missing. Therefore, it is impossible to re-create a high-resolution image even when a super-resolution processing is performed on a low-resolution image captured by a common single-chip color image sensor having a Bayer filter mosaic.

By contrast, when a diameter of a circular motion is set to be two times of the length of a pixel pitch as shown in FIG. 17A, it is possible to move R pixels and B pixels to an area where neither R pixels nor B pixels exist as shown in FIGS. 18A and 18C. In this way, image capturing positions can be equally dispersed, and a super-resolution processing can produce a super-resolution image with high quality. Further, as shown in FIG. 18B, in addition to being originally provided with a large number (50% of total pixels), G pixels are provided in a checkered flag manner so as to scan in surrounding areas, thereby making it possible to fully sample an optical image.

By contrast, when a diameter of a circular motion is set to be more than two times the length of a pixel pitch, a band-shaped area, where R pixels and B pixels cannot be captured, is not generated. However, when a diameter of a circular motion is increased while maintaining a constant angular velocity of a circular motion, a displacement speed of an optical image (that is, circumferential velocity) is increased. In this case, when a same image capturing period (period of storing charge in the image capturing element 31) is given, an optical image is displaced a farther distance so as to increase an integral effect. In other words, an image blurring (the same situation as what is called a motion blurring) occurs, therefore a high frequency component is lost, which is a factor that suppresses the effectiveness of a super-resolution processing.

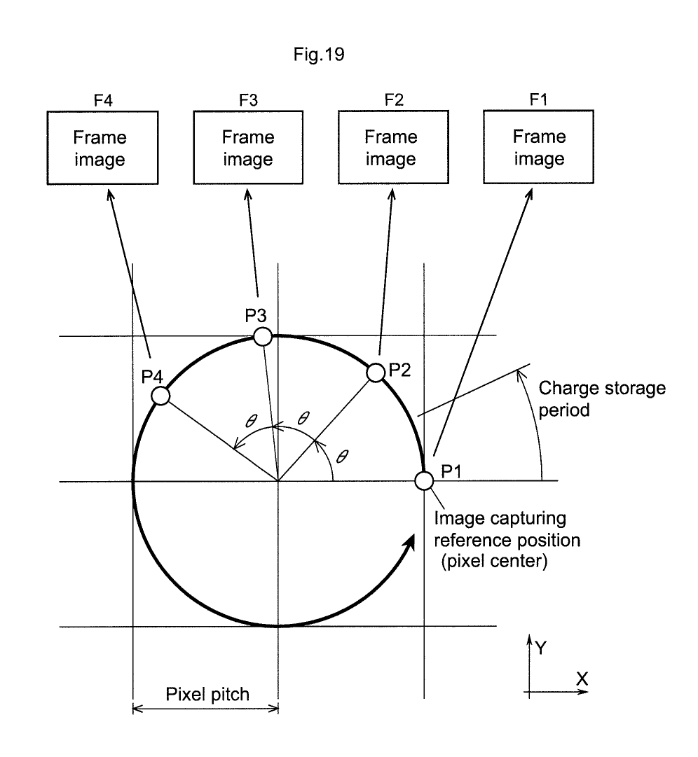

Hereafter, an image capturing (sampling) is described. FIG. 19 is a schematic diagram illustrating a status of an image capturing and images generated from the image capturing.

Herein, images are captured while a circular motion of a pixel relative to an optical image is continuously performed in a direction at a certain speed so as to sequentially generate frame images F1, F2 . . . , the image capturing position of which are slightly displaced. Image capturing reference positions P1, P2 . . . in FIG. 19 illustrate timings of image capturing, at each of which a frame image is generated. In particular, herein, a center position of a pixel at the time of starting an image capturing is shown as an image capturing reference position. Charge storage is started at each image capturing reference position and is completed before the following image capturing reference position, and thereafter a pixel signal is output.

A rotation speed of the circular motion is maintained steady by the above-described PI control. A reference position of a rotation position of the parallel plate 57 (see FIG. 4) is controlled by the origin sensor 70 (see FIG. 8). An influence due to shift width (shift position) generated along with the change of an inclination angle of the parallel plate 57 is suppressed to be small. Therefore, an image capturing position of a frame image captured at each timing is controlled with extremely high accuracy.

Information about the image capturing position, as shown in FIG. 2, is sequentially generated in the shift controller 14 (the calculation processor 76 shown in FIG. 12, more specifically) based on the output from the first magnetic sensor 65 and the origin sensor 70. The information about the image capturing position is transmitted from the image capturing device 1 to the image processing device 2, and then is stored in the memory 23, being associated with a frame-by-frame image data output from the image capturing portion 11. The information about the image capturing position is further referenced by the super-resolution processor 24 during the super-resolution processing, which simplifies the positioning process.

In order to obtain a proper high-resolution image by the super-resolution processing, it is desirable that all pixels be uniformly displaced. It is not preferable that charge storage be conducted at different timings at each pixel line. Therefore, a global shutter system is employed in this example so as to release a shutter of all pixels at a time.

The quality of a high-resolution image obtained by the super-resolution processing can be improved by capturing (sampling) a large number of images at one circular motion performed by a pixel. In particular, herein a circular motion period is set to be non-integral multiple of an image capturing period. With this, it is possible to capture an image at many different positions by repeating circular motions, thus it is possible to generate a large number of images having slightly different image capturing positions so as to improve the quality of the high-resolution images obtained by the super-resolution processing. By contrast, when a circular motion period is set to be integral multiple of the image capturing period, no change is made to the image capturing reference positions even when circular motions are repeated, therefore the number of captured images is limited to the number of the image capturing reference positions that can be accommodated by one circular motion.

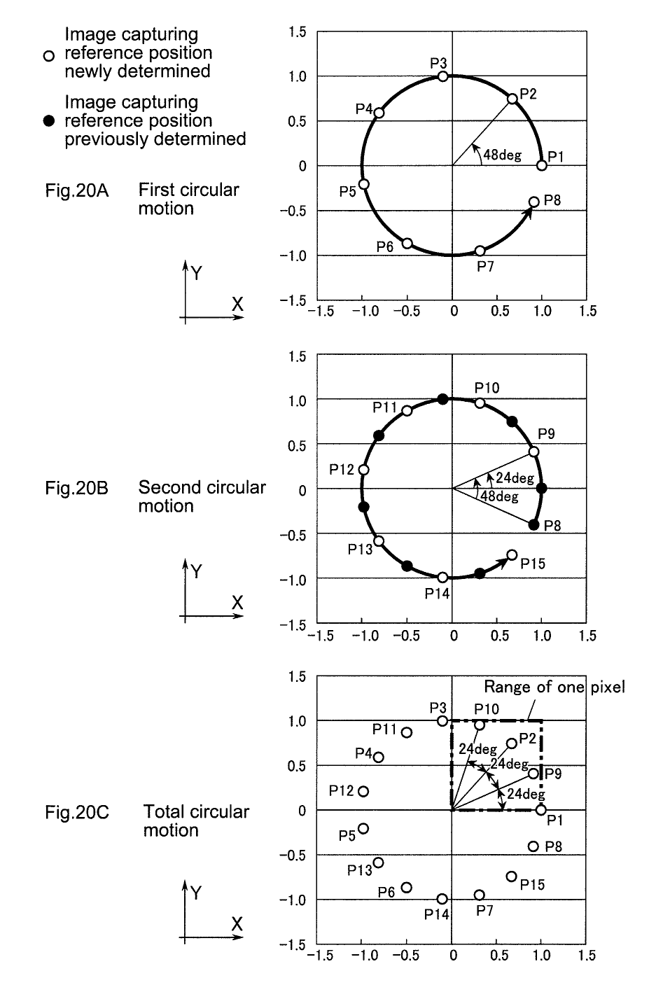

Hereafter, an example of an image capturing reference position is described with a specific ratio of a circular motion period to an image capturing period. FIGS. 20A to 20C are schematic diagrams illustrating statuses of an image capturing reference position in one example of the ratio of the circular motion period to the image capturing period. In the descriptions in FIGS. 20A to 20C, a pixel pitch is set to be one.

In this example, a circular motion period is set to be 7.5 times of the duration of an image capturing period. Herein, when an image capturing period is set to be 30 ms (about 30 frames per second), for example, the circular motion period is 225 ms (=30 ms×7.5). In this case, an image capturing reference position returns to an original position after two circular motions; and an image capturing (sampling) is performed 15 times during the two circular motions. Each image capturing reference position is separated with a relative angle of 48 degree (=360 degree/7.5) from another image capturing reference position.

As shown in FIG. 20A, images are captured at image capturing reference positions P1 to P8 during the first circular motion. As shown in FIG. 20B, during the second circular motion, images are captured at image capturing reference positions P9 to P15, which corresponds to middle points between neighboring two image capturing reference positions in the first circular motion (middle point between P1 and P2, for example). In combination of the first and second circular motions, as shown in FIG. 20C, each image capturing reference position P1 to P15 is separated with a relative angle of 24 degree from another image capturing reference position.

Herein, it is possible to select one out of two processing modes, the first processing mode performing a super-resolution processing based on eight images obtained by the image capturing at the image capturing reference positions P1 to P8 of the first circular motion; and the second processing mode performing a super-resolution processing based on 15 images obtained by the image capturing at the image capturing reference positions P1 to P15 combining the first and second circular motions.

In the first processing mode, two image capturing reference positions, each of which has a different position in both X and Y axis directions, are provided within the range of an original one pixel. Therefore, it is possible to obtain a high-resolution image having substantially two times of the original resolution of the image capturing element 31 in each X and Y axis direction. On the other hand, in the second processing mode, four image capturing reference positions, each of which has a different position in both X and Y axis directions, are provided within the range of an original one pixel. Therefore, it is possible to obtain a high-resolution image having substantially four times of the original resolution of the image capturing element 31 in each X and Y axis direction.

In particular, in the second processing mode, each image capturing reference position P9 to P15 set by the second circular motion becomes middle points of neighboring two of image capturing reference positions P1 to P8, so that the image capturing reference positions are evenly distributed without being disproportionate, thereby making it possible to generate an image that has high adaptability to a super-resolution processing.

Further, it is also possible to perform a super-resolution processing in the image capturing device 1 while the image capturing device 1 is capturing an image. In this case, in the second processing mode, a super-resolution processing may be performed every time when 15 images are obtained by two circular motions.

On the other hand, in the first processing mode, a super-resolution processing may be performed every time eight images are obtained by sequentially shifting the image capturing reference positions. Specifically, in the first super-resolution processing, eight images obtained by the image capturing at the image capturing reference positions P1 to P8 are used. In the second super-resolution processing, eight images obtained by the image capturing at the image capturing reference positions P9 to P15 and P1 are used. Subsequently, the image capturing reference positions are displaced one by one, such as the image capturing reference positions P2 to P9 for the third processing; and the image capturing reference positions P10 to P15 and P1 to P2 for the fourth processing.

As described above, two processing modes can be provided herein. Both processing modes do not need to change a circular motion period (rotation speed of the optical shift mechanism 35) and an image capturing period, thereby providing easy control.

The first image used for the super-resolution processing in each mode is not limited to the image obtained at the original position P1. In the first processing mode, eight images captured during a circular motion starting from an arbitrary position may be used for the super-resolution processing. In the second processing mode, 15 images captured during two circular motions starting from an arbitrary position may be used for the super-resolution processing.

The above-described processing can be employed for a super-resolution processing when using frame images stored in the memory 23 in the image processing device 2, as shown in FIG. 3. The above-described processing is further applicable to a super-resolution processing that is performed while the image capturing device 1 is capturing an image. Especially in the latter case, it is not necessary to return a starting position of an image capturing to the original position P1 even when the processing modes are switched, thereby making it possible to immediately generate high-resolution images with different resolutions by switching the processing modes.

As shown in FIG. 2, an image capturing period is set by a user by use of the inputting portion 26 in the image processing device 2. A circular motion period is set by the period setter 25 based on the set image capturing period. A command signal regarding the set circular motion period is transmitted to the image capturing device 1. The shift controller 14 in the image capturing device 1 operates the optical shift mechanism 35 at a rotation speed corresponding to the set circular motion period, based on the command signal regarding the circular motion period obtained from the image processing device 2.

Further, the user can designate a processing mode (the first processing mode or the second processing mode). As shown in FIG. 3, when a super-resolution processing is performed using frame images stored in the memory 23 in the image processing device 2, a reference image as well as a processing mode is designated by the user. The super-resolution processing is performed by loading an appropriate number of frame images according to the above-designated processing mode, based on the above-designated frame image as a reference image.

Incidentally, the above-mentioned circular motion period can be changed as needed. For example, by setting the circular motion period to be 7.2 times of the duration of the image capturing period, an image capturing reference position returns to an original position after five circular motions, therefore it is possible to perform image capturing (sampling) 36 times during the five circular motions. In this case, each image reference position is separated with a relative angle of 50 degree (=360 degree/7.2) from another image capturing reference position.

The rotational driving device and the image capturing device having thereof according to the present invention provide a long-term dependability, less vibration as well as a space-saving effect. Further, the rotational driving device and the image capturing device having the rotational driving device according to the present invention provide an image capturing device and the like having a rotational driving device that is suitable for generating a high-resolution image by performing a super-resolution processing from a plurality of original images obtained by pixel offset.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications including combinations of features for different embodiments or variations may be possible without departing from the scope of the present invention.

What is claimed is:

1. A rotational driving device comprising:
a rotation body;
a first magnetizer that is provided to the rotation body and faces an outer side of the rotation body in a radial direction;
a second magnetizer that is provided to the rotation body and faces one end of the rotation body in an axial direction;
a plurality of magnetic rotation drivers that rotate the rotation body by generating a magnetic force in a rotation direction between the first magnetizer and the magnetic rotation driver;
a first position detector that detects a position of the rotation body in the radial direction based on magnetism of the first magnetizer;
a second position detector that detects a position of the rotation body in the axial direction based on magnetism of the second magnetizer;
a first position controller that controls the position of the rotation body in the radial direction by generating a radial-direction magnetic force between the first magnetizer and the first position controller based on a detection result by the first position detector; and
a second position controller that controls the position of the rotation body in the axial direction by generating an axial-direction magnetic force between the second magnetizer and the second position controller based on a detection result by the second position detector,
wherein and the first position detector, the second position detector, the first position controller, and the second position controller are provided in an area formed between the magnetic rotation drivers.

2. The rotational driving device according to claim 1, wherein the magnetic rotation drivers are provided in a circumferential direction of the rotation body at equal distance from each other.

3. The rotational driving device according to claim 1, wherein the first position controller comprises a first magnetic body opposing the first magnetizer, and a coil wound around the first magnetic body, and the first position detector is provided to the first magnetic body at one end opposing the first magnetizer.

4. The rotational driving device according to claim 1, wherein the second position controller comprises a second magnetic body opposing the second magnetizer, and a coil wound around the second magnetic body, and the second position detector is provided to the second magnetic body at one end opposing the second magnetizer.

5. The rotational driving device according to claim 3, further comprising:
a position determiner that determines the position of the rotation body based on an output from the position detector; and
a conduction controller that controls a conduction amount of the coil provided to the position controller based on a determination result by the position determiner,
wherein the position determiner and the position controller perform a position determination operation and the position control operation respectively, in a time sharing manner.

6. An image capturing device comprising:
the rotational driving device according to claim 1; and
an image capturing element that performs photoelectric conversion on light from an object and outputs a pixel signal,
wherein the rotation body includes an optical member that displaces an optical image formed on a light-receiving surface of the image capturing element relative to the image capturing element.

7. The image capturing device according to claim 6, comprising:
a capsule member that contains the optical member and is filled with a liquid having a higher refractive index than a reflective index of air,
wherein the magnetic rotation driver, the first position controller, and the second position controller abut an outer surface of the capsule member.

8. A network camera system comprising the image capturing device according to claim 6 and an image processing device connected with each other through a network.

9. The network camera system according to claim 8, wherein
the image capturing device comprising:
a shift controller that causes the rotational driving device to rotate the rotation body at a predetermined speed that defines a rotation period;
an image capturing controller that causes the image capturing element to perform image capturing at a predetermined period; and
a transmitter that transmits frame images sequentially generated through image capturing by the image capturing element to the image processing device,
the image processing device comprising:
a receiver that receives a frame image transmitted from the image capturing device; and
a super-resolution processor that generates a high-resolution image from a plurality of frame images received by the receiver.

10. An image capturing device comprising:
an image capturing element that performs photoelectric conversion on light from an object and outputs a pixel signal;
a lens unit that forms an image on the image capturing element based on light from the object;
a rotation body that includes an optical member that is inclined at a predetermined angle with respect to an optical axis of the lens unit; and a supporting ring configured with a magnetic body disposed on an outer peripheral side of the optical member; and
a rotational driving device that displaces an optical image formed on a light-receiving surface of the image capturing element relative to the image capturing element by changing the inclination direction of the optical member with respect to the optical axis by rotating the rotation body, the rotational driving device comprising:
a first magnetizer that is provided to the supporting ring and faces an outer peripheral surface of the supporting ring;
a second magnetizer that is provided to the supporting ring and faces a first end surface of the supporting ring in a axial direction;
a third magnetizer that is provided to the supporting ring and faces a second end surface of the supporting ring in the axial direction;
a first position controller that maintains a radial-direction position of the optical member by applying a radial-direction magnetic force to the first magnetizer;
a second position controller that maintains an axial-direction position of the optical member by applying an axial-direction magnetic force to at least one of the second magnetizer and the third magnetizer; and
a magnetic rotation driver that rotates the optical member by applying a rotation-direction magnetic force to the first magnetizer, and
wherein, the first magnetizer is magnetized in a polar anisotropy orientation and faces a central portion in the axial direction of an outer peripheral surface of the supporting ring.

11. The image capturing device according to claim 10, wherein the first magnetizer comprises a first ring made of a magnetic material; the second magnetizer comprises a second ring made of a magnetic material; and the third magnetizer comprises a third ring made of a magnetic material,
wherein the second ring and the third ring are adhered to end surfaces spaced from each other in the axial direction of the first ring.

12. The image capturing device according to claim 10, wherein the second magnetizer, the third magnetizer, and the first magnetizer are mounted to a single ring shaped member.

13. The image capturing device according to claim 10, further comprising a capsule member that contains the rotation body and is filled with a liquid having a higher refractive index than a refractive index of the air,
wherein the rotational driving device drives the rotation body such that the rotation body contacts only the liquid.

14. A network camera system comprising the image capturing device according to claim 10 and an image processing device that are connected with each other through a network.

15. The network camera system according to claim 14, wherein
the image capturing device comprising:
a shift controller that causes the rotational driving device to rotate the rotation body at a predetermined speed that defines a rotation period;
an image capturing controller that causes the image capturing element to perform image capturing at a predetermined period; and
a transmitter that transmits frame images sequentially generated through image capturing by the image capturing element to the image processing device,
the image processing device comprising:
a receiver that receives a frame image transmitted from the image capturing device; and
a super-resolution processor that generates a high-resolution image from a plurality of frame images received by the receiver.

16. The image capturing device according to claim 10, wherein said optical member received in a capsule member that is filled with a liquid having a refractive index higher than a refractive index of air, said first position controller maintaining the optical member in a floating state in the liquid in the radial direction and said second position controller maintaining the optical member in a floating state in the axial direction.

17. The image capturing device according to claim 6, wherein said optical member is supported within said capsule member by a supporting ring having a circular shape and supporting said optical member on an inner peripheral side surface of said supporting ring, said first magnetizer provided on said supporting ring facing an outer peripheral side of said supporting ring.

18. The image capturing device according to claim 17, wherein said first magnetizer comprises a polar anisotropic ring magnet.

19. The network camera system according to claim 9, wherein said image capturing controller controlling the image capturing element to perform image capturing in accordance with an image capturing period, said shift controller causing the rotational driving device to rotate the rotation body in accordance with a circular motion period, the circular motion period being a non-integral multiple of the image capturing period.

20. The network camera system according to claim 15, wherein said image capturing controller controls the image capturing element to perform image capturing in accordance with an image capturing period, said shift controller causing the rotational driving device to rotate the rotational body in accordance with a circular motion period, the circular motion period being a non-integral multiple of the image capturing period.
